(19) United States
(12) Patent Application Publication
(10) Pub. No.: US 2026/0256144 A1
(43) Pub. Date: Sep. 3, 2026

(54) FUNGICIDAL MIXTURE COMPOSITION COMPRISING SULPHUR

(71) Applicant: ADAMA MAKHTESHIM LTD., Beer Sheva (IL)

(72) Inventor: Matteo CERNUSCHI, Milan (IT)

(73) Assignee: ADAMA MAKHTESHIM LTD., Beer Sheva (IL)

(21) Appl. No.: 18/846,828

(22) PCT Filed: Mar. 14, 2023
(86) PCT No.: PCT/IL2023/050265

§ 371 Date: Sep. 13, 2024

Related U.S. Application Data
(60) Provisional application No. 63/319,408, filed on Mar. 14, 2022.

(51) Int. Cl. A01N 59/02; A01N 43/40; A01N 43/653; A01P 3/00; A01P 7/04

(52) U.S. Cl. CPC A01N 59/02; A01N 43/40; A01N 43/653; A01P 3/00; A01P 7/04

(57) ABSTRACT

The present invention relates to mixture combinations of active compounds comprising an effective amount of sulphur; an effective amount of at least one fungicide or its salt, for combatting or preventing fungal diseases of crop plants. Methods of controlling mites or insects comprising applying said combinations are also disclosed.

### RELATED APPLICATION/S

This application claims benefits of U.S. Provisional Application No. 63/319,408 filed on Mar. 14, 2022; the entire content of which is hereby incorporated by reference herein. Throughout this application, various publications are cited. Disclosures of the documents and publications referred to herein are hereby incorporated in their entireties by references into this application.

### FIELD OF INVENTION

The present invention relates to mixture combinations of active compounds comprising an effective amount of sulphur; an effective amount of at least one fungicide or its salt, and at least one agrochemically acceptable excipient, for combatting or preventing fungal diseases of crop plants. Methods of controlling mites or insects comprising applying said combinations are also disclosed.

### BACKGROUND OF INVENTION

Elemental sulphur as a potent pesticide is well known for ages. Sulphur is available primarily in its elemental form and formulations namely granules, pellets, powders, and so on are known for providing sulphur in a form for use as a fertilizer or a pesticide. Sulphur not only works as a fungicide but is also used as a supplementary plant nutrient. The formulation of sulphur alone is considered moderately effective against various fungal diseases such as powdery mildew or grey mildew.

The vulnerability of crops to fungal diseases makes fungal disease management one of the major components of the total crop production system. Various fungi are very harmful to crop plants and can significantly reduce crop yields and qualities. Actives like Sulphur or other Fungicides are compounds of natural or synthetic origin which act to protect plants against damage caused by fungi. In spite of the benefits derived from the use of fungicides in agriculture such as protection of crops and improved productivity, it is nowadays desirable to reduce the amount of fungicides used in the fields owing to the potential health risks associated with an intensive use of agrochemicals. Furthermore, repeated usage of a single fungicide often leads to the development of resistance to a specific or a group of fungicides.

The biological properties of known compounds are not entirely satisfactory in the areas of plant disease control, environmental and worker exposure, for example in particular, it has been observed that pathogens become, resistant to pesticides, which are at times administered in higher dosages to achieve the desired control, thereby leading to soil toxicity and other environmental hazards, besides higher costs. Another important issue associated with fungus attacks is the loss of nutrients which leads to a decrease in the overall yield of the crop.

Combinations of fungicides or mixture of one or more fungicides with other crop protection chemical are typically used to broaden spectrum of control, to minimize the doses of chemicals used, to retard resistance development and to reduce the cost of the treatment through additive effect. Although many combinations of one fungicidal agent with one or more crop protection chemicals have been studied, a synergistic effect is rarely attained.

There are some literatures available on fungicidal mixture comprising sulphur. EP2667720 discloses pesticidal composition comprising sulphur, a fungicide and an agrochemical excipient. Ene et al. (Stiinte Agricole Si Silvice, 23, 1990, p. 285-293) relates to the use of Ziram instead of macozeb in fungicide mixtures against wheat leaf diseases at high concentrations or in association with sulphur. FR2585539 relates to a new combination fungicide comprising cymoxanil and wettable sulphur. Pauwels et al. (Mededelingen Van De Faculteit Landbouwwetenschappen, 31, 2, 1976, p. 687-682) relates to the control of cereal diseases with chlorothalonil and chlorothalonil, Maneb and sulphur.

Practical agricultural experience has shown that the repeated and exclusive application of an individual active compound such as sulphur in the control of fungi leads in many cases to a selection of those fungi which have developed natural or adapted resistance against the active compound in question. Effective control of these fungi with the active compound in question is then no longer possible.

Thus there is a need for a selective mixture of sulphur with other fungicidal compound that help prevent or overcome resistance. In order to reduce the risk of fungi becoming resistant to certain active compounds, mixtures of different fungicidal chemicals are nowadays conventionally employed for controlling various fungi. By combining judiciously active compounds having different mechanisms of action, it is possible to ensure successful control over a relatively long period of time.

Active agent mixtures are described in the literature. However, the control over the fungi does not always satisfy the needs of agriculture practice. Additionally, the efficacy of mixtures is not entirely satisfactory in cases of fungi control and/or toxicological and/or environmental effects. Random pesticidal compositions and mixtures do not exert a satisfactory controlling effect in most of the cases, and therefore, there is an urgent need for development of new pesticidal mixtures with one more crop protection chemical having some satisfactory controlling effects.

It is an object of the present invention to provide mixtures and compositions of judiciously selected crop protection chemicals which, when applied at a reduced total amount of active compounds, have improved activity against the harmful fungi. It is an object of the present invention to provide a broadened activity spectrum with prolonged control. It is a further object of the present invention to provide mixtures and compositions comprising sulphur which provide effective resistance management and fungi control, at application rates which are as low as possible. Furthermore, it is also an object of the present invention to provide mixtures and compositions of judiciously selected crop protection chemicals which are to be used for controlling mites or insects comprising applying said mixtures of the said chemicals.

It is an endeavor of the present invention to find that mixtures comprising sulphur and at least one further crop protection chemical are synergistically effective, being applied simultaneously, that is jointly or separately, or in succession, allows better control of fungi than is possible with the individual compounds alone, providing synergistic results and solving at least one of the challenges in the prior art by reducing the dosage rate or enhancing the spectrum of activity with prolonged control or facilitating resistance management which results in increasing the overall yield of the crop.

In light of the above, there is endeavor in the present invention for a fungicidal mixture combination of crop protection chemicals comprising sulphur that exhibit synergistically enhanced action, a broader scope of fungicidal as well as insecticidal activities and reduced cost of treatment.

### SUMMARY OF THE PRESENT INVENTION

We have reasonably found that the object as described above is as a whole or in part achieved by the combination of active compounds defined below.

The present invention relates to a fungicidal mixture combination comprising, as active compounds:
i) an effective amount of a sulphur; and
ii) an effective amount of at least one fungicide selected from the group consisting of:
(a) a contact fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole,
wherein the amount of a sulphur and the amount of the fungicide when applied together is more effective in treating a plant or soil against fungal infection than when each fungicide at the same amount is applied alone.

The mixture combination of the present invention can be a synergistic mixture.

The present invention also provides a fungicidal composition comprising any one of the combinations or mixtures disclosed herein.

The present invention also provides a method of treating a plant or soil against fungal infection comprising applying an effective amount of any one of the combinations, mixtures or compositions disclosed herein to the plant, propagation material of the plant, or soil so as to thereby treat the plant or soil against fungal infection.

The present invention also provides a method of treating a plant or soil against fungal infection comprising applying to the plant, propagation material of the plant, or soil
(i) an effective amount of a sulphur; and
ii) an effective amount of at least one fungicide selected from the group consisting of:
(a) a contact fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole, and prothioconazole,
so as to thereby treat the plant or soil against fungal infection,
wherein the amount of sulphur and the amount of the fungicide when applied together is more effective for treating the plant or soil against fungal infection than when each fungicide at the same amount is applied alone.

The present invention also provides a method of treating a plant or soil against fungal infection comprising applying to the plant, propagation material of the plant, or soil
(i) an effective amount of a sulphur; and
ii) an effective amount of at least one fungicide selected from the group consisting of:
(a) a contact fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole,
so as to thereby treat the plant or soil against fungal infection, wherein the amount of sulphur applied is less than the fungicidally effective amount of sulphur when sulphur is used alone, and/or
wherein the amount of the fungicide applied is less than the fungicidally effective amount of the fungicide when the fungicide is used alone.

The present invention also provides use of any one of the combinations, mixtures or compositions disclosed herein for combatting phytopathogenic diseases as well as mites on crop plants.

The present invention also provides use of any one of the combinations, mixtures or compositions disclosed herein for treating a plant or soil against fungal infection.

The present invention also provides a method of treating a plant or soil against infection by fungi selected from a group comprising Moniliophthora roreri (Frosty pod), Moniliophthora perniciosa (Witches' broom), Microdochium sp. (Seedling blight), Botryosphaeria dothidea (Botryosphaeria Panicle and Shoot Blight), Phyllosticta ampelicida (Black rot), Mycosphaerella fijiensis or the preferred name Pseudocercospora fijiensis (Black sigatoka), Zymoseptoria tritici (Septoria tritici blotch-STB), Ramularia collo-cygni (Ramularia leaf spot), Cercospora zeae-maydis (Gray Leaf Spot), Ramularia areola (Ramularia leaf spot), Cercospora beticola (leaf spot of beet), Ramularia beticola (Ramularia leaf spot), Pseudocercospora musae (Yellow sigatoka), Mycosphaerella arachidis (Early leaf spot), Mycosphaerella berkeleyi (Late leaf spot), Mycosphaerella pyri (Ashy leaf spot of pear), Cercospora sp. (Leaf spot), Septoria glycines (Septoria brown spot), Cercospora kikuchii (Purple Seed Stain), Cladosporium sp. (Scab), Pseudocercospora cantuariensis (Leaf spot of hop), Neopseudocercosporella capsellae (White leaf spot), Cercospora nicotianae (Barn spot), Rhizoctonia solani/Thanatephorus cucumeris (Sheath Blight, Rizoctonia, cucumeris Damping off, Rhizoctonia root and crown rot), Erythricium salmonicolor (Pink Disease), Diaporthe neoviticola (Dead-arm), Kabatiella zeae (Eyespot), Blumeria graminis (Powedery mildew), Erysiphe cichoracearum (Powdery mildew), Sphaerotheca fuliginea (Powdery mildew), Erysiphe necator (Powdery mildew), Podosphaera macularis (Powdery mildew), Podosphaera leucotricha (Powdery mildew), Oidium neolycopersici (Powdery mildew), Erysiphe betae/Erysiphe polygoni (powdery mildew), Erysiphe sp. (Powdery mildew), Podosphaera pannosa (Powdery mildew), Peronospora tabacina (Downy mildew), Guignardia bidwellii (Black rot), Leveillula taurica (Powdery mildew), Erysiphe cruciferarum (Powdery mildew), Erysiphe diffusa (Powdery mildew), Aspergillus sp. (Aspergillus ear rot), Pyrenopeziza brassicae (Light leaf Spot), Phlyctema vagabunda (Bark canker of apple), Blumeriella jaapii (Leaf spot), Botrytis cinerea (Grey mold), Monilinia sp. (Monilia), Monilinia laxa (Monilia), Monilia fructigena (Monilia), Monilia fructicola (Monilia), Sclerotinia sp. (White mould), Sclerotinia sclerotiorum (Sclerotinia stem rot or white mold), Monilinia fructicola (Brown rot blossom), Rhynchosporium secalis (Leaf blotch of cereals), Fusarium sp. (Fusarium head blight, Maize Ear and Kernel Rot), Neonectria galligena (Eye rot), Gibberella fujikuroi (Bakanae disease), Gibberella zeae (Giberrella stalk and ear rot), Gibberella xylarioides (Coffee Wilt Disease), Elsinoë ampelina (Anthracnose of grapevine), Phytophthora sp. (Crown and root rot), Phytophthora palmivora (Black pod), Phytophthora megakarya (Black pod), Phytophthora capsica (Black pod), Pseudoperonospora cubensis (Downy mildew), Plasmopara viticola (Downy mildew), Pseudoperonospora humuli (Downy mildew), Phytophthora infestans (Late blight), Peronospora viciae (Downy mildew), Phytopthora sp. (Downy mildew), Hyaloperonospora parasitica (Downy mildew), Peronospora farinose (Downy mildew), Colletotrichum kahawae (Coffee Berry Disease), Colletotrichum sp. (Anthracnose), Colletotrichum musae (Anthracnose), Colletotrichum spp. (Anthracnose), Glomerella cingulata (Anthracnose), Colletotrichum graminicola (Anthracnose), Glomerella gossypii (Anthracnose), Glomerella cingulata (Fruit rot), Colletotrichum falcatum (Red rot), Colletotrichum destructivum (Anthracnose), Colletotrichum gloeosporioides, Polystigma rubrum (Leaf spot), Plasmodiophora brassicae (Club rot), Corynespora cassiicola (Target spot), Ascochyta rabiei (Chickpea ascochyta blight), Ascochyta gossypiicola (Boll rot), Didymella pomorum (Leaf spot of apple), Ascochyta pisi (Ascochyta blight of pea), Ascochyta fabae (Ascochyta blight), Didymella sp. (Leaf and pod spot), Wilsonomyces carpophilus (Shot-hole of stone fruit), Plenodomus lingam (Phoma stem canker and leaf spot), Neocamarosporium betae (black leg of beet), Pyrenophora tritici-repentis/Drechslera tritici-repentis (Yellow spot), Pyrenophora teres (Net blotch), Setosphaeria turcica (Northern Corn Leaf Blight), Cochliobolus heterostrophus (Southern corn leaf blight), Cochliobolus carbonum (Northern Corn Leaf Spot), Alternaria cucumerina (Leaf blight), Alternaria alternata (Alternaria/Brown spot), Pleospora allii (Brown spot of pear), Alternaria mali (Alternaria blotch of apple), Alternaria sp. (Early blight, Leaf spot), Alternaria solani, Cochliobolus miyabeanus (Brown spot), Helminthosporium sacchari (Eyespot), Venturia inaequalis (Apple scab), Venturia pyrina (Pear scab), Venturia carpophila (Scab), Hemileia vastatrix (Coffee Leaf Rust), Phakopsora pachyrhizi (Asian soybean rust), Phakopsora gossypii (Panama wilt), Phakopsora gossypii (Tropical cotton rust), Puccinia recondita (Brown rust), Puccinia striiformis (Yellow rust), Uromyces betae (Rust), Puccinia sorghi (Common Rust), Uromyces sp. (Rust), Puccinia schedonnardi (Cotton rust), Puccinia cacabata (Southwestern cotton rust), Tranzschelia sp. (Rust), Pyricularia oryzae (Rice Blast), Taphrina deformans (leaf curl), Ustilago maydis (Common Smut), Ustilago scitaminea (Smut), Phaeomoniella chlamydospore (Esca of grapevine).

Most preferred target fungal diseases are Septoria tritici blotch (Zymoseptoria tritici), Yeallow rust (Puccinia striiformis), Brown rust (Puccinia recondite), Ramularia (Ramularia collo-cygni) in cereals

Most preferred target fungal diseases are Powdery mildew (Erysiphe necator), Grey mold (Botrytis cinerea), Black rot (Guignardia bidwellii) in grapes

Most preferred target fungal disease is Cercospora (Cercospora beticola) in sugarbeet

Most preferred target fungal diseases are Apple scab (Venturia Inaequalis), Powdery mildew (Podosphaera leucotricha) in pomefruits.

The present invention preferably provides methods for treating a plant or soil against infection by fungi selected from a group comprising Zymoseptoria tritici, Ramularia collo-cygni, Botrytis cinerea, Colletotrichum gloeosporioides, Alternaria solani and Venturia inaequalis.

The present invention also provides methods of controlling mites or insects comprising applying said combinations by using any one of the combinations, mixtures or compositions disclosed herein, wherein insects are selected from a group comprising Tetranychus urticae and Trialeurodes vaporariorum.

The present invention also provides a kit comprising any one of the combinations, mixtures or compositions disclosed herein.

The present invention also provides a process for the preparation any one of the combinations, mixtures or compositions disclosed herein from individual component parts.

### DETAILED DESCRIPTION OF THE PRESENT INVENTION

### Definitions

Prior to setting forth the present subject matter in detail, it may be helpful to provide definitions of certain terms to be used herein. Unless defined otherwise, all technical and scientific terms used herein have the same meaning as is commonly understood by one of skill in the art to which this subject matter pertains.

As used herein, the term “and/or” includes any and all combinations of one or more of the associated listed items. Expressions such as “at least one of,” when preceding a list of elements, modify the entire list of elements and do not modify the individual elements of the list.

It will be understood that when an element is referred to as being “on” another element, it can be directly in contact with the other element or intervening elements may be present there between. In contrast, when an element is referred to as being “directly on” another element, there are no intervening elements present.

The terminology used herein is for the purpose of describing particular embodiments only and is not intended to be limiting. As used herein, the singular forms “a,” “an,” and “the” are intended to include the plural forms as well, unless the context clearly indicates otherwise.

It will be understood that, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

As used herein, the term “combination” means an assemblage of agrochemicals for application either by simultaneous or contemporaneous application.

As used herein, the term “simultaneous” when used in connection with application of agrochemicals means that the agrochemicals are applied in an admixture, for example, a tank mix. For simultaneous application, the combination may be the admixture or separate containers each containing an agrochemical that are combined prior to application.

As used herein the term “prolonged control” means obtaining fungicidal activity over an extended period after the application of one or more fungicide for controlling fungi infestation of the plant or locus over an extended period of time, before and/or after an infestation or before and/or after damage due to fungi are shown.

As used herein, the term “effective” when used in connection with an amount of the combination, mixture or composition refers to an amount of the combination, mixture or composition that achieve a good level of control of the fungus, pathogen, and/or disease when applied to a plant, propagation material of the plant, or soil.

As used herein, the term “fungicidally effective amount” refers to an amount of the active component that is commercially recommended for use to control fungi. The commercially recommended amount for each active component, often specified as application rates of the commercial formulation, may be found on the label accompanying the commercial formulation. The commercially recommended application rates of the commercial formulation may vary depending on factors such as the plant species and the fungus to be controlled.

As used herein, the term “treating a plant or soil against fungal infection” includes, but is not limited to, protecting the plant or soil against fungal attack, preventing fungal infection of the plant or soil, controlling fungal disease infecting the plant or soil, and reducing fungal infection of the plant or soil.

As used herein, the term “more effective for controlling fungal disease” includes, but is not limited to, increasing efficacy of fungal disease control and reducing the amount of time needed to achieve a given level of fungal control.

As used herein, the term “more effective for protecting the plant or soil against fungal attack” includes, but is not limited to, prolonging the duration of protection against fungal attack after application and extending the protection period against fungal attack.

As used herein, the term “agriculturally acceptable inert additives” is defined as any substance that itself is not an active ingredient but is added to the composition such as thickening agent, sticking agents, surfactants, anti-oxidation agent, anti-foaming agents and thickeners.

As used herein, the term “tank mix” means that two or more chemical pesticides or compositions are mixed in the spray tank at the time of spray application.

As used herein, the term “ready mix” means a composition that may be applied to plants directly after dilution. The composition comprises the combination of the active ingredients. The term “mixture” or “combination” refers, but is not limited to, a combination in any physical form, e.g., blend, solution, alloy, or the like.

As used herein the term “plant” or “crop” includes reference to whole plants, plant organs (e.g. leaves, stems, twigs, roots, trunks, limbs, shoots, fruits etc.), plant cells, or plant seeds. This term also encompasses plant crops such as fruits. The term “plant” may also include the propagation material thereof, which may include all the generative parts of the plant such as seeds and vegetative plant material such as cuttings and tubers, which can be used for the multiplication of the plant. It may also include spores, corms, bulbs, rhizomes, sprouts basal shoots, stolons, and buds and other parts of plants, including seedlings and young plants, which are to be transplanted after germination or after emergence from soil.

As used herein, the term “locus” includes a habitat, breeding ground, plant, propagation material, soil, area, material or environment in which a pest is growing or may grow.

As used herein, the term “cultivated plants” includes plants which have been modified by breeding, mutagenesis or genetic engineering. Genetically modified plants are plants, which genetic material has been modified by the use of recombinant DNA techniques. Typically, one or more genes have been integrated into the genetic material of such a plant in order to improve certain properties of the plant.

The term “plant health” comprises various sorts of improvements of plants that are not connected to the control of pests. For example, advantageous properties that may be mentioned are improved crop characteristics including: emergence, crop yields, protein content, oil content, starch content, more developed root system (improved root growth), improved stress tolerance (e.g. against drought, heat, salt, UV, water, cold), reduced ethylene (reduced production and/or inhibition of reception), increase in plant height, bigger leaf blade, less dead basal leaves, stronger tillers, greener leaf color, pigment content, photosynthetic activity, less input needed (such as fertilizers or water), less seeds needed, more productive tillers, earlier flowering, early grain maturity, less plant verse (lodging), increased shoot growth, enhanced plant vigor, increased plant stand and early and better germination; or any other advantages familiar to a person skilled in the art.

Throughout the application, descriptions of various embodiments use the term “comprising”; however, it will be understood by one of skill in the art, that in some specific instances, an embodiment can alternatively be described using the language “consisting essentially of” or “consisting of”.

As used herein, the term “locus” includes a habitat, breeding ground, plant, propagation material, soil, area, material or environment in which a pest is growing or may grow.

As used herein the term “ha” refers to hectare.

As used herein, the term “g” refers to gram, and “L” or “I” refers to litre.

As used herein, the term “more effective” includes, but is not limited to, increasing efficacy of pesticidal disease control, prolonging protection and reducing the amount of time needed to achieve a given level of pesticidal control, prolonging the duration of protection against pest attack after application and extending the protection period against pest attack and/or reducing the amount of time needed to achieve a level of pest control compared to when each pesticide at the same amount is applied alone.

The term “enhancing crop plants” as used herein means improving one or more of plant quality, plant vigor, nutrient uptake, root system, tolerance to stress factors, and/or yield in a plant to which the mixture or composition described herein has been applied as compared to a control plant grown under the same conditions except to which the mixture or composition described herein has not been applied.

The term “enhancing roots system” as may be used herein means the roots system is improved qualitatively or quantitatively in a plant to which the mixture or composition described herein has been applied as compared to the roots systems in a control plant grown under the same conditions except to which the mixture or composition described herein has not been applied. Enhanced roots systems include but are not limited to improved visual appearance and composition of the roots system (i.e., improved color, density, and uniformity), increased root growth, a more developed root system, stronger and healthier roots, improved plant stand, and increased roots system weight.

The term “improving plant quality” as used herein means that one or more traits are improved qualitatively or quantitatively in a plant to which the mixture or composition described herein has been applied as compared to the same trait in a control plant grown under the same conditions except to which the mixture or composition described herein has not been applied. Such traits include but are not limited to improved visual appearance and composition of the plant (i.e., improved color, density, uniformity, compactness), reduced ethylene (reduced production and/or inhibition of reception), improved visual appearance and composition of harvested material (i.e., seeds, fruits, leaves, vegetables, shoot/stem/cane), improved carbohydrate content (i.e., increased quantities of sugar and/or starch, improved sugar acid ratio, reduction of reducing sugars, increased rate of development of sugar), improved protein content, improved oil content and composition, improved nutritional value, reduction in anti-nutritional compounds, increased nutrient uptake, stronger and healthier roots, improved organoleptic properties (i.e., improved taste), improved consumer health benefits (i.e., increased levels of vitamins and antioxidants), improved post-harvest characteristics (i.e., enhanced shelf-life and/or storage stability, easier processability, easier extraction of compounds), and/or improved seed quality (i.e., for use in following seasons).

As used herein, the term “plants” refers to any and all physical parts of a plant, including but not limited to seeds, seedlings, saplings, roots, tubers, stems, stalks, foliage, and fruits.

As used herein, the term “surfactant” means an agriculturally acceptable material which imparts emulsifiability, stability, spreading, wetting, dispersibility or other surface-modifying properties. Examples of suitable surfactants include non-ionic, anionic, cationic and ampholytic surfactants.

For purposes of better understanding the present teachings and in no way limiting the scope of the teachings, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques. In this regard, use of the term “about” herein specifically includes ±10% from the indicated values in the range. In addition, the endpoints of all ranges directed to the same component or property herein are inclusive of the endpoints, are independently combinable, and include all intermediate points and ranges.

Unless otherwise specified, references to percentages are by weight (wt.) percentages of the active compounds in the composition of this invention are based on the total weight of active ingredients in the composition, i.e., the active compounds themselves, exclusive of any amounts of solvents, carriers, dispersants, stabilizers or other materials which may be present.

It is further understood that where a parameter range is provided, all integers within that range, and tenths thereof, are also provided by the subject matter. For example, “0.1% to 50%” includes 0.1%, 0.2%, 0.3%, 0.4% etc. up to 50%.

When a ratio herein is to be “X:1 or higher”, it is meant that the ratio is Y:1, where Y is X or greater, and when a ratio is herein to be “X:1 or lower”, it is meant that the ratio is Z:1, where

Z is X or less. The same logic follows for ratios that are “1: X or higher” and “1:X or lower”.

### Fungicidal Mixture Combination

It has been surprisingly found that by combining a sulphur with one or more crop fungicidal compounds, mixture combinations are produced, that exhibit a broad spectrum of control and high efficacy against a very wide range of fungi, as well as having long residual effect under different climate conditions. The mixtures and compositions of the present invention are based in part on the finding that application of the mixture combination of the present invention to a locus or area where fungicidal control is desired results in improved control of fungi and prevents further infestation.

In some embodiments, the combination provides a higher fungicidal activity than that envisaged on the basis of the sum of activities of each of sulphur and the fungicides found therein. Such a combination allows the reduced dosages of the individual fungicide which can damage agriculturally important plants.

In an embodiment, the present invention relates to a fungicidal mixture combination comprising, as active compounds:
i) an effective amount of a sulphur; and
ii) an effective amount of at least one fungicide selected from the group consisting of:
(a) a contact fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole,
It has now been surprisingly found that a composition comprising a combination of i) an effective amount of a sulphur, when mixed in certain ratios with an effective amount of at least one fungicide selected from the group consisting of:
(a) a fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole,
has a synergistically increased action on the control of fungal diseases in crop plants without causing phytotoxicity to the plants. A particular advantage of the composition according to the present invention is that this synergistic effect among the active components allows for a reduction of the total amount of sulphur or fungicide used on the crops while still having a good control of fungal diseases.

It has now been found that a combination comprising a sulphur and at least one fungicide selected from the group consisting of:
(a) a contact fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole,
has an increased action on protecting plant or soil against fungal attack, preventing fungal infection of plant or soil, controlling fungal disease infecting plant or soil, and reducing fungal infection of plant or soil without causing phytotoxicity to the plant. The increased action can be a synergistically increased action. A particular advantage of the combination according to the present invention is that this synergistic effect among the active components allows for a reduction of the total amount of sulphur or fungicide used on the plant or soil while still having a good effect of treating the plant or soil against fungal infection. Synergism occurs when the effect of two or more compounds exceeds the effect of the compounds when used alone.

It has also been found that these combinations help prevent fungal attack and thus enables the use of a reduced amount of sulphur or fungicides at a later stage of the plant development. The present combination is capable of limiting or destroying the microorganisms which occur on plants or parts of plants of a variety of crops of useful plants, and even on parts of plants which are formed at a later point in time and remain unharmed by such microorganisms.

In order to solve one of the problems encountered in the state of the art, the present invention developed a method for reducing the phytotoxicity of fungicide on crops, in particular potatoes, grapes, cereals, sugar beet and Pome fruits. It has now been found that sulphur when mixed with at least one of the active ingredients a), and/or b) shows a clearly reduced phytotoxicity.

One particularly advantageous method according to the invention consists in: 1) adding to the spray tank sulphur in an amount lying in the range of from 500 g a.i./ha to 5000 g a.i./ha, preferably from 500 g a.i./ha to 3500 g a.i./ha, more preferably from 800 g a.i./ha to 3500 g a.i./ha, together with at least one of the active ingredients a) and/or b) as well as the adjuvants; 2) triggering the spray tank agitator; and 3) once the mixture is homogenized, applying the mixture on the crop.

The combinations according to the invention may also comprise more than one of the active components a), b), if broadening of the spectrum of disease control is desired. The present invention also provides a synergistic combination comprising (i) an amount of sulphur, and an amount of at least one additional fungicide selected from the group consisting of:
(a) a contact fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole,
The present invention also provides a combination comprising (i) an amount of sulphur, and an amount of at least one additional fungicide selected from the group consisting of:
(a) a contact fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole,
wherein the combination is more effective for treating a plant or soil against fungal disease than when sulphur and the fungicide at the same amount is applied alone.

The present invention also provides a combination comprising (a) an amount of sulphur, and an amount of at least one fungicide selected from the group consisting of:
(a) a contact fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole,
wherein the amount of sulphur and the amount of the fungicide when applied together is more effective in treating a plant or soil against fungal infection than when sulphur or fungicide at the same amount is applied alone.

The present invention also provides a fungicidal composition comprising any one of the combinations or mixtures disclosed herein.

In some embodiments, the combination, mixture or composition comprises sulphur and a contact fungicide acting as uncoupler of oxidative phosphorylation. In some embodiments, the amount of the contact fungicide in the mixture is less than the fungicidally effective amount of the contact fungicide when the contact fungicide is used alone.

In some embodiments, the combination, mixture or composition comprises sulphur and a triazole fungicide. In some embodiments, the amount of the triazole fungicide in the mixture is less than the fungicidally effective amount of the triazole fungicide when the triazole fungicide is used alone.

In some embodiments, the combination, mixture or composition is more effective for treating the plant or soil against fungal infection than each fungicide at the same amount is applied alone.

In some embodiments, the combination, mixture or composition is more effective for protecting the plant or soil against fungal attack infection than when sulphur or the fungicide at the same amount is applied alone. In some embodiments, the combination, mixture or composition is more effective for preventing fungal infection of the plant or soil infection than when sulphur or each fungicide at the same amount is applied alone. In some embodiments, the combination, mixture or composition is more effective for controlling fungal disease infecting the plant or soil infection than when sulphur or each fungicide at the same amount is applied alone. In some embodiments, the combination, mixture or composition is more effective for reducing fungal infection of the plant or soil infection than when sulphur or each fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when sulphur at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the contact fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than when the triazole fungicide at the same amount is applied alone.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than sulphur when used at its fungicidally effective amount.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the contact fungicide when used at its fungicidally effective amount.

In some embodiments, the combination, mixture or composition is more effective for protecting a plant from fungal attack, preventing fungal infection of the plant or soil, controlling fungal disease infecting the plant or soil, and/or reducing fungal infection of the plant or soil than the triazole fungicide when used at its fungicidally effective amount.

The term contact fungicide as used herein denotes a fungicide that remains at the site where it is applied but does not travel within the plant. This fungicide may be selected from the group comprising Fluazinam. Preferably the contact fungicide contained in the composition according to the invention is Fluazinam.

The triazole fungicide contained in the composition according to the invention may be selected from the group consisting of difenoconazole, tebuconazole, metconazole, fenbuconazole, flusilazole, cyproconazole, Mefentrifluconazole, Ipfentrifluconazole, Fluoxytioconazole, prothioconazole or a mixture thereof. In a preferred embodiment, triazole fungicide is difenoconazole.

The present invention also provides a mixture for controlling crop disease, the mixture comprising
i) an effective amount of a sulphur; and
ii) an effective amount of at least one fungicide selected from the group consisting of:
(a) a contact fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole,
wherein the crop diseases are selected from a group comprising Frosty pod, Witches' broom, Seedling blight, Botryosphaeria Panicle and Shoot Blight, Black rot, Black sigatoka, Septoria tritici blotch-STB, Ramularia leaf spot, Gray Leaf Spot, Ramularia leaf spot, leaf spot of beet, Ramularia leaf spot, Yellow sigatoka, Early leaf spot, Late leaf spot, Ashy leaf spot of pear, Leaf spot, Septoria brown spot, Purple Seed Stain, Scab, Leaf spot of hop, White leaf spot, Barn spot, Sheath Blight, Rizoctonia, cucumeris Damping off, Rhizoctonia root and crown rot, Pink Disease, Dead-arm, Eyespot, Powdery mildew, Downy mildew, Black rot, Powdery mildew, Aspergillus ear rot, Light leaf Spot, Bark canker of apple, Leaf spot, Grey mold, Monilia, White mould, Sclerotinia stem rot, Brown rot blossom, Leaf blotch of cereals, Fusarium head blight, Maize Ear and Kernel Rot, Eye rot, Bakanae disease, Giberrella stalk and ear rot, Coffee Wilt Disease, Anthracnose of grapevine, Crown and root rot, Black pod, Downy mildew, Late blight, Coffee Berry Disease, Anthracnose, Fruit rot, Red rot, Leaf spot, Club rot, Target spot, Chickpea ascochyta blight, Boll rot, Leaf spot of apple, Ascochyta blight of pea, Ascochyta blight, Leaf and pod spot, Shot-hole of stone fruit, Phoma stem canker and leaf spot, black leg of beet, Yellow spot, Net blotch, Northern Corn Leaf Blight, Southern corn leaf blight, Northern Corn Leaf Spot, Leaf blight, Alternaria/Brown spot, Brown spot of pear, Alternaria blotch of apple, Early blight, Leaf spot, Brown spot, Eyespot, Apple scab, Pear scab, Scab, Coffee Leaf Rust, Asian soybean rust, Panama wilt, Tropical cotton rust, Brown rust, Yellow rust, Rust, Common Rust, Cotton rust, Southwestern cotton rust, Rice Blast, leaf curl, Common Smut, Smut, Esca of grapevine.

Most preferred target fungal diseases are Septoria tritici blotch (Zymoseptoria tritici), Yeallow rust (Puccinia striiformis), Brown rust (Puccinia recondite), Ramularia (Ramularia collo-cygni) in cereals.

Most preferred target fungal diseases are Powdery mildew (Erysiphe necator), Grey mold (Botrytis cinerea), Black rot (Guignardia bidwellii) in grapes.

Most preferred target fungal disease is Cercospora (Cercospora beticola) in sugarbeet

Most preferred target fungal diseases are Apple scab (Venturia Inaequalis), Powdery mildew (Podosphaera leucotricha) in pomefruits.

The present invention also provides a mixture for controlling fungus, the mixture comprising
i) an effective amount of a sulphur; and
ii) an effective amount of at least one fungicide selected from the group consisting of:
(a) a contact fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole.
wherein the fungi are selected from a group comprising Moniliophthora roreri (Frosty pod), Moniliophthora perniciosa (Witches' broom), Microdochium sp. (Seedling blight), Botryosphaeria dothidea (Botryosphaeria Panicle and Shoot Blight), Phyllosticta ampelicida (Black rot), Mycosphaerella fijiensis or the preferred name Pseudocercospora fijiensis (Black sigatoka), Zymoseptoria tritici (Septoria tritici blotch-STB), Ramularia collo-cygni (Ramularia leaf spot), Cercospora zeae-maydis (Gray Leaf Spot), Ramularia areola (Ramularia leaf spot), Cercospora beticola (leaf spot of beet), Ramularia beticola (Ramularia leaf spot), Pseudocercospora musae (Yellow sigatoka), Mycosphaerella arachidis (Early leaf spot), Mycosphaerella berkeleyi (Late leaf spot), Mycosphaerella pyri (Ashy leaf spot of pear), Cercospora sp. (Leaf spot), Septoria glycines (Septoria brown spot), Cercospora kikuchii (Purple Seed Stain), Cladosporium sp. (Scab), Pseudocercospora cantuariensis (Leaf spot of hop), Neopseudocercosporella capsellae (White leaf spot), Cercospora nicotianae (Barn spot), Rhizoctonia solani/Thanatephorus cucumeris (Sheath Blight, Rizoctonia, cucumeris Damping off, Rhizoctonia root and crown rot), Erythricium salmonicolor (Pink Disease), Diaporthe neoviticola (Dead-arm), Kabatiella zeae (Eyespot), Blumeria graminis (Powedery mildew), Erysiphe cichoracearum (Powdery mildew), Sphaerotheca fuliginea (Powdery mildew), Erysiphe necator (Powdery mildew), Podosphaera macularis (Powdery mildew), Podosphaera leucotricha (Powdery mildew), Oidium neolycopersici (Powdery mildew), Erysiphe betae/Erysiphe polygoni (powdery mildew), Erysiphe sp. (Powdery mildew), Podosphaera pannosa (Powdery mildew), Peronospora tabacina (Downy mildew), Guignardia bidwellii (Black rot), Leveillula taurica (Powdery mildew), Erysiphe cruciferarum (Powdery mildew), Erysiphe diffusa (Powdery mildew), Aspergillus sp. (Aspergillus ear rot), Pyrenopeziza brassicae (Light leaf Spot), Phlyctema vagabunda (Bark canker of apple), Blumeriella jaapii (Leaf spot), Botrytis cinerea (Grey mold), Monilinia sp. (Monilia), Monilinia laxa (Monilia), Monilia fructigena (Monilia), Monilia fructicola (Monilia), Sclerotinia sp. (White mould), Sclerotinia sclerotiorum (Sclerotinia stem rot or white mold), Monilinia fructicola (Brown rot blossom), Rhynchosporium secalis (Leaf blotch of cereals), Fusarium sp. (Fusarium head blight, Maize Ear and Kernel Rot), Neonectria galligena (Eye rot), Gibberella fujikuroi (Bakanae disease), Gibberella zeae (Giberrella stalk and ear rot), Gibberella xylarioides (Coffee Wilt Disease), Elsinoë ampelina (Anthracnose of grapevine), Phytophthora sp. (Crown and root rot), Phytophthora palmivora (Black pod), Phytophthora megakarya (Black pod), Phytophthora capsica (Black pod), Pseudoperonospora cubensis (Downy mildew), Plasmopara viticola (Downy mildew), Pseudoperonospora humuli (Downy mildew), Phytophthora infestans (Late blight), Peronospora viciae (Downy mildew), Phytopthora sp. (Downy mildew), Hyaloperonospora parasitica (Downy mildew), Peronospora farinose (Downy mildew), Colletotrichum kahawae (Coffee Berry Disease), Colletotrichum sp. (Anthracnose), Colletotrichum musae (Anthracnose), Colletotrichum spp. (Anthracnose), Glomerella cingulata (Anthracnose), Colletotrichum graminicola (Anthracnose), Glomerella gossypii (Anthracnose), Glomerella cingulata (Fruit rot), Colletotrichum falcatum (Red rot), Colletotrichum destructivum (Anthracnose), Colletotrichum gloeosporioides, Polystigma rubrum (Leaf spot), Plasmodiophora brassicae (Club rot), Corynespora cassiicola (Target spot), Ascochyta rabiei (Chickpea ascochyta blight), Ascochyta gossypiicola (Boll rot), Didymella pomorum (Leaf spot of apple), Ascochyta pisi (Ascochyta blight of pea), Ascochyta fabae (Ascochyta blight), Didymella sp. (Leaf and pod spot), Wilsonomyces carpophilus (Shot-hole of stone fruit), Plenodomus lingam (Phoma stem canker and leaf spot), Neocamarosporium betae (black leg of beet), Pyrenophora tritici-repentis/Drechslera tritici-repentis (Yellow spot), Pyrenophora teres (Net blotch), Setosphaeria turcica (Northern Corn Leaf Blight), Cochliobolus heterostrophus (Southern corn leaf blight), Cochliobolus carbonum (Northern Corn Leaf Spot), Alternaria cucumerina (Leaf blight), Alternaria alternata (Alternaria/Brown spot), Pleospora allii (Brown spot of pear), Alternaria mali (Alternaria blotch of apple), Alternaria sp. (Early blight, Leaf spot), Alternaria solani, Cochliobolus miyabeanus (Brown spot), Helminthosporium sacchari (Eyespot), Venturia inaequalis (Apple scab), Venturia pyrina (Pear scab), Venturia carpophila (Scab), Hemileia vastatrix (Coffee Leaf Rust), Phakopsora pachyrhizi (Asian soybean rust), Phakopsora gossypii (Panama wilt), Phakopsora gossypii (Tropical cotton rust), Puccinia recondita (Brown rust), Puccinia striiformis (Yellow rust), Uromyces betae (Rust), Puccinia sorghi (Common Rust), Uromyces sp. (Rust), Puccinia schedonnardi (Cotton rust), Puccinia cacabata (Southwestern cotton rust), Tranzschelia sp. (Rust), Pyricularia oryzae (Rice Blast), Taphrina deformans (leaf curl), Ustilago maydis (Common Smut), Ustilago scitaminea (Smut), Phaeomoniella chlamydospore (Esca of grapevine).

Most preferred target fungi are selected from a group comprising Zymoseptoria tritici, Ramularia collo-cygni, Botrytis cinerea, Colletotrichum gloeosporioides, Alternaria solani and Venturia inaequalis.

Specific compositions according to the invention are: sulphur and fluazinam; sulphur and difenoconazole, and sulphur and mefentrifluconazole.

In some embodiments, the combination, mixture or composition comprises sulphur and fluazinam. In some embodiments, the combination, mixture or composition comprises sulphur and difenoconazole. In some embodiments, the combination, mixture or composition comprises sulphur and mefentrifluconazole.

The combination according to the invention may also comprise more than one of the active components a), and/or b), if broadening the spectrum of the disease control is desired. In some embodiments, the combination, mixture or composition comprises two additional fungicides.

In some embodiments, the mixture is a tank mix. The amount of combination of the invention to be applied, will depend on various factors such as the compound employed, the subject of the treatment (plant, soil, seed), the type of treatment (e.g. spraying, dusting, seed dressing), the purpose of the treatment (prophylactic or therapeutic), the type of fungi to be treated and the application time.

In a preferred embodiment, in the fungicidal composition according to the invention, the weight ratio of sulphur to a) and/or b) lies in the range of from 1:1 to 100:1.

In another embodiment, in the fungicidal composition according to the invention, the weight ratio of sulphur to a) and/or b) lies in the range of from 1:1 to 60:1.

In some embodiments, the weight ratio of sulphur to the contact fungicide is from 2:1 to 30:1. In some embodiments, the weight ratio of sulphur to the contact fungicide is from 2:1 to 20:1.

In some embodiments, the weight ratio of sulphur to the triazole fungicide is from 5:1 to 100:1. In some embodiments, the weight ratio of sulphur to the triazole fungicide is from 8:1 to 60:1.

In some embodiments, the weight ratio of sulphur to fluazinam is from 2:1 to 30:1. In some embodiments, the weight ratio of sulphur to fluazinam is from 2:1 to 20:1.

In some embodiments, the weight ratio of sulphur to difenoconazole is from 5:1 to 100:1. In some embodiments, the weight ratio of sulphur to difenoconazole is from 8:1 to 60:1.

In some embodiments, the weight ratio of sulphur to mefentrifluconazole is from 5:1 to 100:1. In some embodiments, the weight ratio of sulphur to mefentrifluconazole is from 8:1 to 60:1.

In some embodiments, the combination, mixture or composition reduces the amount of time needed to achieve a level of fungal control compared to when each fungicide at the same amount is applied alone. For example, if each fungicide applied alone achieves 50% control of fungal disease 7 days after application, the combination, mixture or composition disclosed herein achieves 50% control of fungal diseases 2 days after application where each fungicide is applied at the rate.

In some embodiments, the amount of time is reduced by at least 1 day, 2 days, 3 days, 4 day, 5 days, 7 days, 10 days, 14 days or 21 days, or 28 days.

In some embodiments, the combination, mixture or composition is more effective for protecting the plant or soil against fungal attack than when each fungicide at the same amount is applied alone.

In some embodiments, the combination, mixture or composition prolongs protection against the fungus compared to when each fungicide at the same amount is applied alone.

In some embodiments, protection is prolonged by at least 7 days, 14 day, 21 days, or 28 day.

In some embodiments, the combination, mixture or composition disclosed herein extends the protection period against fungal attack compared to when each fungicide at the same amount is applied alone.

In some embodiments, the protection period is extended by at least 7 days, 14 days, 21 days, or 28 days.

In some embodiments, the combination, mixture or composition is effective for increasing plant development compared to when each fungicide at the same amount is applied alone. Increasing plant development includes, but is not limited to, enhancing the root systems, enhancing shoot of the crop plant, enhancing greening effect, enhancing plant vigor and/or enhancing plant potential yield.

In some other embodiments, the combination, mixture or composition is effective for increasing control of phytophagous mites compared to when each fungicide at the same amount is applied alone.

In some embodiments, plant vigor is assessed using the relative vigor index. In some embodiments, plant vigor is increased by at least 1%, 5%, 10, 20%, 30%, 40%, 50%, 60%, 70%, 80%, or 90%.

In some embodiments, enhancement in root system is measured by root weight. In some embodiments, root weight is increased by at least 1%, 5%, 10, 20%, 30%, 40%, 50%, 60%, 70%, 80%, or 90%.

In some embodiments, enhancement in shoot is measured by shoot weight. In some embodiments, shoot weight is increased by at least 1%, 5%, 10, 20%, 30%, 40%, 50%, 60%, 70%, 80%, or 90%.

In some embodiments, the fungicidal composition further comprises at least one agrochemically acceptable excipient.

In an embodiment, in the fungicidal composition according to the invention, the combination of sulphur mixed with a) and/or b) represents 0.5 wt % to 95 wt % of the total weight of the fungicide composition.

In some embodiments, the amount of sulphur and a) and/or b) represents 0.5 wt % to 95 wt % of the total weight of the combination, mixture, or composition. In some embodiments, the amount of sulphur and a) and/or b) represents 0.5 wt % to 95 wt % of the total weight of the combination, mixture, or composition.

The present invention also discloses a method of combatting phytopathogenic diseases on crop plants which comprises applying to the crop plant or to the locus thereof the fungicide composition according to the invention. A preferred method of applying the invention composition comprises the application of said composition to the aerial parts of the plant, especially the foliage.

The present invention also discloses a method of combatting phytopathogenic diseases on crop plants which comprises applying to the crop plant or to the locus thereof the combination, mixture or composition according to the invention. A preferred method of applying the invention combination, mixture or composition comprises the application of said combination, mixture or composition to the aerial parts of the plant, especially the foliage.

The present invention also provides a method of treating a plant or soil against fungal infection comprising applying an effective amount of any one of the combinations, mixtures, or compositions disclosed herein to the plant, propagation material of the plant, or soil so as to thereby treat the plant or soil against fungal infection.

The present invention also provides a method of preventing fungal infection of a plant or soil comprising applying an effective amount of any one of the combinations, mixtures, or compositions disclosed herein to the plant, propagation material of the plant, or soil so as to thereby prevent fungal infection of the plant or soil.

The present invention also provides a method of controlling fungal disease infecting a plant or soil comprising applying an effective amount of any one of the combinations, mixtures, or compositions disclosed herein to the plant, propagation material of the plant, or soil so as to thereby control the fungal disease infecting the plant or soil.

The present invention also provides a method of reducing fungal infection of a plant or soil comprising applying an effective amount of any one of the combinations, mixtures, or compositions disclosed herein to the plant, propagation material of the plant, or soil so as to thereby reduce fungal infection of the plant or soil.

The present invention also provides a method for prolonging the period of protection against fungal infection comprising applying any one of the combinations, mixtures or compositions disclosed herein to a plant or soil.

In some embodiments, the method comprises applying sulphur and the additional fungicide at any one of the rates described herein.

The rate at which the fungicidal composition according to the invention is applied will depend upon the particular type of fungus to be controlled, the degree of control required and the timing and method of application. In general, the composition of the disclosure can be applied at an application rate lying in the range of from about 50 g a.i./ha to about 5000 g a.i./ha based on the total amount of active ingredients in the composition.

In an embodiment, the fungicidal composition according to the invention is applied at a rate lying in the range of from about 60 g a.i./ha to about 4000 g a.i./ha. In a more particular embodiment, the fungicidal composition according to the invention is applied at a rate lying in the range of from about 75 g a.i./ha to about 4000 g a.i./ha, even more particularly in the range of from about 100 g a.i./ha to about 3500 g a.i./ha.

The components of the combination, mixture or composition of the present disclosure can be applied either separately or as part of a multipart fungicidal system. The components of the combination, mixture or composition of the present disclosure can be applied either separately or as part of a multipart fungicidal system. Consequently, the methods and uses disclosed herein include preparation of the combination, mixture and composition from the component parts prior to application or use.

In some embodiments, the components of the combination, mixture or composition are applied simultaneously.

In some embodiments, the components of the combination, mixture or composition are applied contemporaneously.

In some embodiments, the sulphur and/or mixture thereof is applied at least one time during a growth season.

In some embodiments, sulphur and/or mixture thereof is applied two or more times during a growth season.

In some embodiments, sulphur and/or mixture thereof described herein are applied as a soil application. In some embodiments, the mixtures and/or compositions described herein are applied as a foliar application.

In some embodiments, the combination, mixture or composition is applied at least one time during a growth season.

In some embodiments, the combination, mixture or composition is applied two or more times during a growth season.

In some embodiments, the combination, mixture or composition described herein are applied as a soil application. In some embodiments, the combination, mixture or composition described herein are applied as a foliar application.

The rate at which the combination, mixture or composition disclosed herein is applied will depend upon the particular type of fungus to be controlled, the degree of control required and the timing and method of application. In general, the combination, mixture or composition described herein can be applied at an application rate of between about 60 g/ha and about 4000 g/ha.

In some embodiments, the sulphur is applied at a rate between 500-5000 g a.i./ha. In some embodiments, the sulphur is applied at a rate between 700-4000 g a.i./ha. In some embodiments, the sulphur is applied at a rate between 800-3500 g a.i./ha. In some embodiments, the sulphur is applied at a rate between 800-2400 g a.i./ha, for example, in Grapes. In some embodiments, the sulphur is applied at a rate about 3500 g a.i./ha, for example, in Pomefruits.

In some embodiments, the contact fungicide is applied at a rate of 100-500 g a.i./ha. In some embodiments, the contact fungicide is applied at a rate of 150-400 g a.i./ha. In some embodiments, the contact fungicide is applied at a rate of 200-350 g a.i./ha.

In some embodiments, fluazinam is applied at a rate of 100-500 g a.i./ha. In some embodiments, fluazinam is applied at a rate of 100-400 g a.i./ha. In some embodiments, fluazinam is applied at a rate of 150-350 g a.i./ha, for example, in potatoes, fruit trees, grapes.

In some embodiments, the triazole fungicide is applied at a rate of 25-300 g a.i./ha. In some embodiments, the triazole fungicide is applied at a rate of 25-200 g a.i./ha. In some embodiments, the triazole fungicide is applied at a rate of 25-125 g a.i./ha.

In some embodiments, difenoconazole is applied at a rate of 25-300 g a.i./ha. In some embodiments, difenoconazole is applied at a rate of 25-200 g a.i./ha. In some embodiments, difenoconazole is applied at a rate of 25-125 g a.i./ha.

In some embodiments, mefentrifluconazole is applied at a rate of 25-300 g a.i./ha. In some embodiments, mefentrifluconazole is applied at a rate of 25-200 g a.i./ha. In some embodiments, mefentrifluconazole is applied at a rate of 25-125 g a.i./ha.

In some embodiments, sulphur and the fungicide are applied simultaneously. In some embodiments, sulphur and the additional fungicide(s) are applied contemporaneously.

The fungicidal compositions according to the invention are effective against a broad spectrum of phytopathogenic fungi, especially the ones belonging to the following classes: Ascomycetes (e.g. Venturia, Podosphaera, Ervsiphe, Monilinia, Mvcosphaerella, Uncinula): Basidiomycetes (e.g. the genus Hemileia, Rhizoctonia, Puccinia, Phakopsora); Fungi imperfecti (e.g. Botrytis. Helminthosporium, Rhvnchosporium, Fusarium. Septoria, Cercospora, Alternaria, Pyricularia and Pseudocercosporella herpotrichoides (Tapesia spp.).

In a preferred embodiment the target fungi according to the present invention are selected from a group comprising Zymoseptoria tritici, Ramularia collo-cygni, Botrytis cinerea, Colletotrichum gloeosporioides, Alternaria solani and Venturia inaequalis.

In particular, the novel compositions are useful against, brown and yellow rusts, especially Asian soybean rust (Phakopsora pachyrhizi), but also leaf spots, powdery mildew, Cercospora, Ramularia, Hemileia vastatrix.

The combinations, mixtures and compositions according to the invention are effective against a broad spectrum of mites and phytopathogenic fungi, especially the ones belonging to the following classes: Ascomycetes (e.g. Venturia, Podosphaera, Ervsiphe, Monilinia, Mvcosphaerella, Uncinula): Basidiomycetes (e.g. the genus Hemileia, Rhizoctonia, Puccinia, Phakopsora); Fungi imperfecti (e.g. Botrytis. Helminthosporium, Rhvnchosporium, Fusarium. Septoria, Cercospora, Alternaria, Pyricularia and Pseudocercosporella herpotrichoides (Tapesia spp.).

In a preferred embodiment the target mites or insects according to the present invention are selected from a group comprising Tetranychus urticae and Trialeurodes vaporariorum.

The composition according to the invention can be used as a fungicide, i.e. for combatting fungal diseases that have already contaminated crop plants but also for the prevention of fungal attacks.

The combination, mixture or composition according to the invention can be used as a fungicide, i.e. for combatting fungal diseases that have already contaminated crop plants but also for the prevention of fungal attacks.

Target crops for the areas of indication disclosed herein comprise the following species of plants: cereals (wheat, barley, rye, oats, rice, sorghum and related crops); beet (sugar beet and fodder beet); pomes, stone fruit and soft fruit (apples, pears, plums, peaches, almonds, cherries, strawberries, raspberries and blackberries); leguminous plants (beans, lentils, peas, soybeans); oil plants (rape, mustard, poppy, olives, sunflowers, coconut, castor oil plants, cocoa beans, groundnuts); cucumber plants (marrows, cucumbers, melons); fibre plants (cotton, flax, hemp, jute); citrus fruit (oranges, lemons, grapefruit, mandarins); vegetables (spinach, lettuce, asparagus, cabbages, carrots, onions, tomatoes, potatoes, paprika); lauraceae (avocados, cinnamon, camphor); or plants such as maize, tobacco, nuts, coffee, sugar cane, tea, vines, hops, bananas and natural rubber plants, as well as ornamentals (flowers, shrubs, broad-leaved trees and evergreens, such as conifers). This list does not represent any limitation.

In some embodiments, the composition of present invention is intended for use on crop of potatoes, fruit trees, grapes, cereals, sugar beet.

In some embodiments, the combination, mixture or composition is for treating crop against fungal infection. Crop includes, but is not limited to, arable crops, vegetables and fruits. In some embodiments, the combination, mixture or composition according to the invention is intended for use on crops of corn, soybean, dry bean, cotton, wheat or coffee. In some embodiments, the combination, mixture or composition according to the invention is intended for use on soybean, dry bean, corn, cotton, cereals, coffee, rice, pome fruit, grapevine, zucchini and/or tomato. In some embodiment, the crop is soybean. In some embodiment, the crop is dry bean. In some embodiment, the crop is corn. In some embodiment, the crop is cotton. In some embodiment, the crop is cereal. In some embodiment, the crop is coffee. In some embodiment, the crop is rice. In some embodiments, the crop is grapevine. In some embodiments, the crop is a pome fruit, preferably apple. In some embodiments, the crop is zucchini. In some embodiment, the crop is tomato.

Number and rates of application depend on the biological and climatic environment of the pathogen. Alternatively, the active ingredients can reach the plant from the soil or water via the root system (systemic action) by drenching the locus of the plant with a liquid preparation (for example in rice growing) or incorporating the substances into the soil in solid form, for example in the form of granules (soil application). The inventive composition can also be applied to seed kernels for the purposes of seed treatment (coating), either by soaking the roots or kernels in succession with a liquid preparation of an active ingredient or by coating them with a moist or dry preparation which already comprises the combination. In addition, other types of application to plants are possible in specific cases, for example the targeted treatment of buds or fruit-bearing parts of the plant.

The inventive combination, mixture or composition can also be applied to seed kernels for the purposes of seed treatment (coating), either by soaking the roots or kernels in succession with a liquid preparation of an active ingredient or by coating them with a moist or dry preparation which already comprises the combination. In addition, other types of application to plants are possible in specific cases, for example the targeted treatment of buds or fruit-bearing parts of the plant.

The composition of the invention may be formulated into any conventional type of formulation. The composition of the invention may be employed in any conventional form, especially in the form of water dispersible granules, coated granules, emulsifiable concentrate, suspension concentrate, microemulsion, oil dispersion, suspo-emulsion, capsule suspension, a mixed formulation of capsule suspension and suspension concentrate.

Suitable carriers and adjuvants may be solid or liquid and correspond to the substances ordinarily employed in formulation technology, such as, e.g. natural or regenerated mineral substances, solvents, dispersants, wetting fungicides, tackifiers, thickeners, binding fungicides or fertilisers. Such carriers are for example described in WO 96/22690.

Such compositions may be produced in conventional manner, e.g. by mixing the active ingredients with appropriate adjuvants (diluents or solvents and optionally other formulating ingredients such as surfactants).

Particularly formulations to be applied in spraying forms such as water dispersible concentrates or wettable powders may contain surfactants such as wetting and dispersing fungicides, e.g. the condensation product of formaldehyde with naphthalene sulphonate, an alkylarylsulphonate, a lignin sulphonate, a fatty alkyl sulphate, and ethoxylated alkylphenol and an ethoxylated fatty alcohol.

The composition according to the invention is generally formulated in various ways using formulation adjuvants, such as carriers, solvents and surface-active substances. The formulations can be in various physical forms, e.g. in the form of dusting powders, gels, wettable powders, water-dispersible granules, water-dispersible tablets, effervescent pellets, emulsifiable concentrates, microemulsifiable concentrates, oil-in-water emulsions, oil-flowables, aqueous dispersions, oily dispersions, suspo-emulsions, capsule suspensions, emulsifiable granules, soluble liquids, water-soluble concentrates (with water or a water-miscible organic solvent as carrier), impregnated polymer films or in other forms known e.g. from the Manual on Development and Use of FAO and WHO Specifications for Pesticides, United Nations, First Edition, Second Revision (2010). Such formulations can either be used directly or diluted prior to use. The dilutions can be made, for example, with water, liquid fertilisers, micronutrients, biological organisms, oil or solvents. The formulations can be prepared e.g. by mixing the active ingredient with the formulation adjuvants in order to obtain compositions in the form of finely divided solids, granules, solutions, dispersions or emulsions. The active ingredients can also be formulated with other adjuvants, such as finely divided solids, mineral oils, oils of vegetable or animal origin, modified oils of vegetable or animal origin, organic solvents, water, surface-active substances or combinations thereof.

The active ingredients can also be contained in microcapsules. Microcapsules contain the active ingredients in a porous carrier. This enables the active ingredients to be released into the environment in controlled amounts (e.g. slow-release). Microcapsules usually have a diameter of from 0.1 to 500 microns. They contain active ingredients in an amount of from about 25 to 95% by weight of the capsule weight. The active ingredients can be in the form of a monolithic solid, in the form of fine particles in solid or liquid dispersion or in the form of a suitable solution. The encapsulating membranes can comprise, for example, natural or synthetic rubbers, cellulose, styrene/butadiene copolymers, polyacrylonitrile, polyacrylate, polyesters, polyamides, polyureas, polyurethane or chemically modified polymers and starch xanthates or other polymers that are known to the person skilled in the art. Alternatively, very fine microcapsules can be formed in which the active ingredient is contained in the form of finely divided particles in a solid matrix of base substance, but the microcapsules are not themselves encapsulated.

The formulation adjuvants that are suitable for the preparation of the formulations according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, di ethylene glycol butyl ether, di ethylene glycol ethyl ether, di ethylene glycol methyl ether,/V,/V-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethylhexanol, ethylene carbonate, 1,1,1-trichloroethane, 2-heptanone, alpha-pinene, d-limonene, ethyl lactate, ethylene glycol, ethylene glycol butyl ether, ethylene glycol methyl ether, gamma-butyrolactone, glycerol, glycerol acetate, glycerol diacetate, glycerol triacetate, hexadecane, hexylene glycol, isoamyl acetate, isobornyl acetate, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol, propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloroethylene, ethyl acetate, amyl acetate, butyl acetate, propylene glycol methyl ether, diethylene glycol methyl ether, methanol, ethanol, isopropanol, and alcohols of higher molecular weight, such as amyl alcohol, tetrahydrofurfuryl alcohol, hexanol, octanol, ethylene glycol, propylene glycol, glycerol, V-methyl-2-pyrrolidone and the like.

Suitable solid carriers are, for example, talc, titanium dioxide, pyrophyllite clay, silica, attapulgite clay, kieselguhr, limestone, calcium carbonate, bentonite, calcium montmorillonite, cottonseed husks, wheat flour, soybean flour, pumice, wood flour, ground walnut shells, lignin and similar substances.

A large number of surface-active substances can advantageously be used in both solid and liquid formulations, especially in those formulations which can be diluted with a carrier prior to use. Surface-active substances may be anionic, cationic, non-ionic or polymeric and they can be used as emulsifiers, wetting fungicides or suspending fungicides or for other purposes. Typical surface-active substances include, for example, salts of alkyl sulfates, such as diethanolammonium lauryl sulfate; such as calcium dodecylbenzenesulfonate; alkylphenol/alkylene oxide addition products, such as nonylphenol ethoxylate; alcohol/alkylene oxide addition products, such as tridecylalcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryltrimethylammonium chloride, polyethylene glycol esters of fatty acids, such as polyethylene glycol stearate; block copolymers of ethylene oxide and propylene oxide; and salts of mono- and di-alkylphosphate esters.

Further adjuvants that can be used in pesticidal formulations include crystallisation inhibitors, viscosity modifiers, suspending fungicides, dyes, anti-oxidants, foaming fungicides, light absorbers, mixing auxiliaries, antifoams, complexing fungicides, neutralising or pH-modifying substances and buffers, corrosion inhibitors, fragrances, wetting fungicides, take-up enhancers, micronutrients, plasticisers, glidants, lubricants, dispersants, thickeners, antifreezes, microbicides, and liquid and solid fertilisers.

The formulations according to the invention can include an additive comprising an oil of vegetable or animal origin, a mineral oil, alkyl esters of such oils or mixtures of such oils and oil derivatives. The amount of oil additive in the formulation according to the invention is generally from 0.01 to 10%, based on the mixture to be applied. For example, the oil additive can be added to a spray tank in the desired concentration after a spray mixture has been prepared. Preferred oil additives comprise mineral oils or an oil of vegetable origin, for example rapeseed oil, olive oil or sunflower oil, emulsified vegetable oil, alkyl esters of oils of vegetable origin, for example the methyl derivatives, or an oil of animal origin, such as fish oil or beef tallow. Preferred oil additives comprise alkyl esters of C8-C22 fatty acids, especially the methyl derivatives of 02-08 fatty acids, for example the methyl esters of lauric acid, palmitic acid and oleic acid (methyl laurate, methyl palmitate and methyl oleate, respectively).

A seed dressing formulation is applied in a manner known per se to the seeds employing the combination of the invention and a diluent in suitable seed dressing formulation form, e.g. as an aqueous suspension or in a dry powder form having good adherence to the seeds. Such seed dressing formulations are known in the art. Seed dressing formulations may contain the single active ingredients or the combination of active ingredients in encapsulated form, e.g. as slow release capsules or microcapsules.

The present invention also provides a package comprising any one of the combinations, mixtures or compositions disclosed herein.

In some embodiments, the package comprises instructions for using the combination, mixture or composition for protecting a plant from fungal attack. In some embodiments, the package comprises instructions for using the combination, mixture or composition for controlling fungal disease infecting a plant. In some embodiments, the instructions comprise application rates, application times, target fungal pathogen, and/or target plant as described herein.

The present invention also provides a process of preparing a combination, mixture or composition comprising
(i) an effective amount of a sulphur; and
ii) an effective amount of at least one fungicide selected from the group consisting of:
(a) a contact fungicide acting as uncoupler of oxidative phosphorylation selected from a group comprising Fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole,
wherein the process comprises the steps of:
(i) obtaining the amount of sulphur and the amount of the additional fungicide(s), and
(ii) mixing the obtained amount of sulphur and the additional fungicide to obtain the combination, mixture or composition.

In some embodiments, the amount of sulphur in the combination, mixture or composition is less than the fungicidally effective amount of sulphur when sulphur is used alone.

In some embodiments, the amount of the additional fungicide(s) in the combination, mixture or composition is less than the fungicidally effective amount of the additional fungicide(s) when the additional fungicide(s) is used alone.

In some embodiments, step (iii) is performed in a tank to obtain a tank mix.

In some embodiments, the process further comprises adding an agrochemically acceptable carrier to the combination, mixture or composition.

Each embodiment disclosed herein is contemplated as being applicable to each of the other disclosed embodiments. Thus, all combinations of the various elements described herein are within the scope of the invention. In addition, the elements recited in the composition embodiments can be used in the combination, mixture (including synergistic mixture), package, method and use embodiments described herein and vice versa.

The present invention is illustrated and further described in more detail with reference to the following non-limiting examples. The following examples illustrate the practice of the present subject matter in some of its embodiments but should not be construed as limiting the scope of the present subject matter. Other embodiments will be apparent to one skilled in the art from consideration of the specification and examples. It is intended that the specification, including the examples, is considered exemplary only without limiting the scope and spirit of the present subject matter.

### Method of Use

The present invention provides a method for enhancing crop plants development and/or and/or improving plant potential yield comprising applying an effective amount of the any one of the mixtures or compositions disclosed herein to one or more plants, the locus thereof or propagation material thereof.

The present invention provides a method for improving plant potential yield comprising applying an effective amount of the any one of the mixtures or the compositions disclosed herein to one or more plants, the locus thereof or propagation material thereof so as to thereby improve plant potential yield.

The present invention provides a method for treating a plant or soil against fungal infection by controlling fungi with an effective amount of the any one of the mixtures or the compositions disclosed herein so as to thereby control the fungi.

The present invention also provides a method for control of insects by contacting the insect or their food supply, habitat, breeding grounds or their locus with an effective amount of the any one of the mixtures or the compositions disclosed herein so as to thereby control insects.

In an embodiment, this invention provides a method for treating a plant or soil against fungal infection by controlling the fungi with an effective amount of the mixture combination of sulphur and an effective amount of at least one fungicide selected from the group consisting of (a) a contact fungicide acting as uncoupler of oxidative phosphorylation, and (b) a triazole fungicide, as mentioned above or the composition thereof, thereby controlling the said fungi.

In another embodiment, this invention also provides a method for control of insects by contacting the insect or their food supply, habitat, breeding grounds or their locus with an effective amount of the mixture combination of sulphur and an effective amount of at least one fungicide selected from the group consisting of (a) a contact fungicide acting as uncoupler of oxidative phosphorylation, and (b) a triazole fungicide, as mentioned above or the composition thereof, thereby controlling the said insects.

In an embodiment, this invention provides a method for treating a plant or soil against fungal infection by controlling the fungi with an effective amount of the mixture combination of sulphur and an effective amount of at least one fungicide selected from the group consisting of (a) a contact fungicide acting as uncoupler of oxidative phosphorylation, and (b) a triazole fungicide, as mentioned above or the composition thereof, thereby controlling the said fungi, wherein fungi are selected from a group comprising Zymoseptoria tritici, Ramularia collo-cygni, Botrytis cinerea, Colletotrichum gloeosporioides, Alternaria solani and Venturia inaequalis.

In an embodiment, this invention provides a method for treating a plant or soil against fungal infection by controlling the fungi, Zymoseptoria tritici, with an effective amount of the mixture combination of sulphur and an effective amount of at least one fungicide selected from the group consisting of (a) a contact fungicide acting as uncoupler of oxidative phosphorylation, and (b) a triazole fungicide, as mentioned above or the composition thereof, thereby controlling the said fungi.

In an embodiment, this invention provides a method for treating a plant or soil against fungal infection by controlling the fungi, Zymoseptoria tritici, with an effective amount of the mixture combination of sulphur and an effective amount of a contact fungicide acting as uncoupler of oxidative phosphorylation, in a weight ratio from 2:1 to 30:1, thereby controlling the said fungi.

In an embodiment, this invention provides a method for treating a plant or soil against fungal infection by controlling the fungi, Zymoseptoria tritici, with an effective amount of the mixture combination of sulphur and an effective amount of fluazinam, in a weight ratio from 2:1 to 30:1, thereby controlling the said fungi.

In an embodiment, this invention provides a method for treating a plant or soil against fungal infection by controlling the fungi, Zymoseptoria tritici, with an effective amount of the mixture combination of sulphur and an effective amount of a triazole fungicide, in a weight ratio from 5:1 to 100:1, thereby controlling the said fungi.

In an embodiment, this invention provides a method for treating a plant or soil against fungal infection by controlling the fungi, Zymoseptoria tritici, with an effective amount of the mixture combination of sulphur and an effective amount of difenoconazole, in a weight ratio from 5:1 to 100:1, thereby controlling the said fungi.

In an embodiment, this invention provides a method for treating a plant or soil against fungal infection by controlling the fungi, Ramularia collo-cygni, with an effective amount of the mixture combination of sulphur and an effective amount of at least one fungicide selected from the group consisting of (a) a contact fungicide acting as uncoupler of oxidative phosphorylation, and (b) a triazole fungicide, as mentioned above or the composition thereof, thereby controlling the said fungi.

In an embodiment, this invention provides a method for treating a plant or soil against fungal infection by controlling the fungi, Ramularia collo-cygni, with an effective amount of the mixture combination of sulphur and an effective amount of a contact fungicide acting as uncoupler of oxidative phosphorylation, in a weight ratio from 2:1 to 30:1, thereby controlling the said fungi.

In an embodiment, this invention provides a method for treating a plant or soil against fungal infection by controlling the fungi, Ramularia collo-cygni, with an effective amount of the mixture combination of sulphur and an effective amount of fluazinam, in a weight ratio from 2:1 to 30:1, thereby controlling the said fungi.

In an embodiment, this invention provides a method for treating a plant or soil against fungal infection by controlling the fungi, Ramularia collo-cygni, with an effective amount of the mixture combination of sulphur and an effective amount of a triazole fungicide, in a weight ratio from 5:1 to 100:1, thereby controlling the said fungi.

In an embodiment, this invention provides a method for treating a plant or soil against fungal infection by controlling the fungi, Ramularia collo-cygni, with an effective amount of the mixture combination of sulphur and an effective amount of difenoconazole, in a weight ratio from 5:1 to 100:1, thereby controlling the said fungi.

In an embodiment, this invention provides a method for treating a plant or soil against fungal infection by controlling the fungi, Botrytis cinerea, with an effective amount of the mixture combination of sulphur and an effective amount of at least one fungicide selected from the group consisting of (a) a contact fungicide acting as uncoupler of oxidative phosphorylation, and (b) a triazole fungicide, as mentioned above or the composition thereof, thereby controlling the said fungi.

In an embodiment, this invention provides a method for treating a plant or soil against fungal infection by controlling the fungi, Botrytis cinerea, with an effective amount of the mixture combination of sulphur and an effective amount of a contact fungicide acting as uncoupler of oxidative phosphorylation, in a weight ratio from 2:1 to 30:1, thereby controlling the said fungi.

In an embodiment, this invention provides a method for treating a plant or soil against fungal infection by controlling the fungi, Botrytis cinerea, with an effective amount of the mixture combination of sulphur and an effective amount of fluazinam, in a weight ratio from 2:1 to 30:1, thereby controlling the said fungi.

In an embodiment, this invention provides a method for treating a plant or soil against fungal infection by controlling the fungi, Botrytis cinerea, with an effective amount of the mixture combination of sulphur and an effective amount of a triazole fungicide, in a weight ratio from 5:1 to 100:1, thereby controlling the said fungi.

In an embodiment, this invention provides a method for treating a plant or soil against fungal infection by controlling the fungi, Botrytis cinerea, with an effective amount of the mixture combination of sulphur and an effective amount of difenoconazole, in a weight ratio from 5:1 to 100:1, thereby controlling the said fungi.

In an embodiment, this invention provides a method for treating a plant or soil against fungal infection by controlling the fungi, Colletotrichum gloeosporioides, with an effective amount of the mixture combination of sulphur and an effective amount of at least one fungicide selected from the group consisting of (a) a contact fungicide acting as uncoupler of oxidative phosphorylation, and (b) a triazole fungicide, as mentioned above or the composition thereof, thereby controlling the said fungi.

In an embodiment, this invention provides a method for treating a plant or soil against fungal infection by controlling the fungi, Colletotrichum gloeosporioides, with an effective amount of the mixture combination of sulphur and an effective amount of a contact fungicide acting as uncoupler of oxidative phosphorylation, in a weight ratio from 2:1 to 30:1, thereby controlling the said fungi.

In an embodiment, this invention provides a method for treating a plant or soil against fungal infection by controlling the fungi, Colletotrichum gloeosporioides, with an effective amount of the mixture combination of sulphur and an effective amount of fluazinam, in a weight ratio from 2:1 to 30:1, thereby controlling the said fungi.

In an embodiment, this invention provides a method for treating a plant or soil against fungal infection by controlling the fungi, Colletotrichum gloeosporioides, with an effective amount of the mixture combination of sulphur and an effective amount of a triazole fungicide, in a weight ratio from 5:1 to 100:1, thereby controlling the said fungi.

In an embodiment, this invention provides a method for treating a plant or soil against fungal infection by controlling the fungi, Colletotrichum gloeosporioides, with an effective amount of the mixture combination of sulphur and an effective amount of difenoconazole, in a weight ratio from 5:1 to 100:1, thereby controlling the said fungi.

In an embodiment, this invention provides a method for treating a plant or soil against fungal infection by controlling the fungi, Alternaria solani, with an effective amount of the mixture combination of sulphur and an effective amount of at least one fungicide selected from the group consisting of (a) a contact fungicide acting as uncoupler of oxidative phosphorylation, and (b) a triazole fungicide, as mentioned above or the composition thereof, thereby controlling the said fungi.

In an embodiment, this invention provides a method for treating a plant or soil against fungal infection by controlling the fungi, Alternaria solani, with an effective amount of the mixture combination of sulphur and an effective amount of a contact fungicide acting as uncoupler of oxidative phosphorylation, in a weight ratio from 2:1 to 30:1, thereby controlling the said fungi.

In an embodiment, this invention provides a method for treating a plant or soil against fungal infection by controlling the fungi, Alternaria solani, with an effective amount of the mixture combination of sulphur and an effective amount of fluazinam, in a weight ratio from 2:1 to 30:1, thereby controlling the said fungi.

In an embodiment, this invention provides a method for treating a plant or soil against fungal infection by controlling the fungi, Alternaria solani, with an effective amount of the mixture combination of sulphur and an effective amount of a triazole fungicide, in a weight ratio from 5:1 to 100:1, thereby controlling the said fungi.

In an embodiment, this invention provides a method for treating a plant or soil against fungal infection by controlling the fungi, Alternaria solani, with an effective amount of the mixture combination of sulphur and an effective amount of difenoconazole, in a weight ratio from 5:1 to 100:1, thereby controlling the said fungi.

In an embodiment, this invention provides a method for treating a plant or soil against fungal infection by controlling the fungi, Venturia inaequalis, with an effective amount of the mixture combination of sulphur and an effective amount of at least one fungicide selected from the group consisting of (a) a contact fungicide acting as uncoupler of oxidative phosphorylation, and (b) a triazole fungicide, as mentioned above or the composition thereof, thereby controlling the said fungi.

In an embodiment, this invention provides a method for treating a plant or soil against fungal infection by controlling the fungi, Venturia inaequalis, with an effective amount of the mixture combination of sulphur and an effective amount of a contact fungicide acting as uncoupler of oxidative phosphorylation, in a weight ratio from 2:1 to 30:1, thereby controlling the said fungi.

In an embodiment, this invention provides a method for treating a plant or soil against fungal infection by controlling the fungi, Venturia inaequalis, with an effective amount of the mixture combination of sulphur and an effective amount of fluazinam, in a weight ratio from 2:1 to 30:1, thereby controlling the said fungi.

In an embodiment, this invention provides a method for treating a plant or soil against fungal infection by controlling the fungi, Venturia inaequalis, with an effective amount of the mixture combination of sulphur and an effective amount of a triazole fungicide, in a weight ratio from 5:1 to 100:1, thereby controlling the said fungi.

In an embodiment, this invention provides a method for treating a plant or soil against fungal infection by controlling the fungi, Venturia inaequalis, with an effective amount of the mixture combination of sulphur and an effective amount of difenoconazole, in a weight ratio from 5:1 to 100:1, thereby controlling the said fungi.

In another embodiment, this invention also provides a method for control of insects by contacting the insect or their food supply, habitat, breeding grounds or their locus with an effective amount of the mixture combination of sulphur and an effective amount of at least one fungicide selected from the group consisting of (a) a contact fungicide acting as uncoupler of oxidative phosphorylation, and (b) a triazole fungicide, as mentioned above or the composition thereof, thereby controlling the said insects, wherein the insects are selected from a group comprising Tetranychus urticae and Trialeurodes vaporariorum.

In another embodiment, this invention also provides a method for control of the insect, Tetranychus urticae by contacting the insect or their food supply, habitat, breeding grounds or their locus with an effective amount of the mixture combination of sulphur and an effective amount of a contact fungicide acting as uncoupler of oxidative phosphorylation, as mentioned above or the composition thereof, in a weight ratio from 2:1 to 30:1, thereby controlling the said insect.

In another embodiment, this invention also provides a method for control of the insect, Tetranychus urticae by contacting the insect or their food supply, habitat, breeding grounds or their locus with an effective amount of the mixture combination of sulphur and an effective amount of fluazinam, in a weight ratio from 2:1 to 30:1, thereby controlling the said insect.

In another embodiment, this invention also provides a method for control of the insect, Trialeurodes vaporariorum by contacting the insect or their food supply, habitat, breeding grounds or their locus with an effective amount of the mixture combination of sulphur and an effective amount of a contact fungicide acting as uncoupler of oxidative phosphorylation, as mentioned above or the composition thereof, in a weight ratio from 2:1 to 30:1, thereby controlling the said insect.

In another embodiment, this invention also provides a method for control of the insect, Trialeurodes vaporariorum by contacting the insect or their food supply, habitat, breeding grounds or their locus with an effective amount of the mixture combination of sulphur and an effective amount of fluazinam, in a weight ratio from 2:1 to 30:1, thereby controlling the said insect.

The following representative examples illustrate the practice of the present invention in some of its embodiments but should not be construed as limiting the scope of the invention. Other embodiments will be apparent to one skilled in the art from consideration of the specification and examples. It is intended that the specification, including the examples, is considered exemplary only without limiting the scope and coverage of the invention.

In some embodiments, the mixture or synergistic mixture comprises one or more additional active ingredient. In some embodiments, the mixture or synergistic mixture comprises one or more additional non-active ingredients.

While the present disclosure of the invention may be susceptible to various modifications and alternative forms, specific embodiments have been described by way of example in detail herein. However, it is understood that the present disclosure is not intended to be limited to the particular forms disclosed. Rather, the present disclosure is to cover all modifications, equivalents, and alternatives falling within the scope of the present disclosure as defined by the following claims and their legal equivalents.

### Examples

Experiments were carried out to determine the technically improved effects (e.g. synergy, crop yield, etc.) of the mixture combination which comprises a mixture of i) a sulphur and ii) at least one fungicide selected from the group consisting of a contact fungicide acting as uncoupler of oxidative phosphorylation and a triazole fungicide.

A mixture combination may be prepared by thoroughly mixing sulphur (weight %) with fluazinam (weight %). Also, in a separate experiment, mixture combination may be prepared by thoroughly mixing sulphur (weight %) with difenoconazole (weight %)

Different concentrations of each of the active ingredients are applied to different fungi. The percent control may be determined sometime after treatment.

A synergistic effect exists whenever the action of a combination of active ingredients is greater than the sum of the action of each of the ingredients alone. Therefore, a synergistic combination is a combination of active ingredients having an action that is greater than the sum of the action of each active ingredient alone, and a synergistically effective amount is an effective amount of a synergistic combination.

Colby's method is used to determine if synergy exists for a combination of active ingredients. According to Colby, the expected action (E) of active ingredients A+B is:

$$E = A + B - ( \frac{A B}{100} )$$

where E=expected efficacy, A and B=the efficacy of two active ingredients A and B at a given dose.

When the percentage of control observed (O) for the combination is greater than the expected (E) percentage, there is a synergistic effect. The synergism ratio (R) is calculated as the ratio between the expected values and observed values. If the synergism ratio (R) between observed and expected is >1 then synergy is exhibited, if R=1 then the effect is additive and if R<1 then the mix is antagonistic.

For a more detailed description of the Colby formula, see Colby, S. R. “Calculating synergistic and antagonistic responses of herbicide combination,” Weeds, Vol. 15, pages 20-22; 1967; see also Limpel et al., Proc. NEWCC 16:48-53 (1962).

The fungicidal compounds A (sulphur) and B (mix partner) are formulated as equivalent compositions to eliminate the effects of differing formulation inerts on biological activity. Efficacy of the fungicidal compositions is evaluated with reference to a scale of 0% to 100% in comparison with untreated control plots. 0 means no control and 100 means complete control of the target disease.

The experiments were conducted by applying commercially available formulations of Sulphur and other mixture partners, alone or with their tank-mixed compositions. The compositions were diluted with water.

The active ingredients used in the experiments are having following formulation types and the concentrations:

| Active | Formulation | |
|---|---|---|
| ingredient | type | Concentration |
| Sulphur | SL | 700 gr/Liter |
| Sulphur | WG | 800 gr/kg |
| Difenoconazole | SC | 250 gr/Liter |
| Fluazinam | SC | 500 gr/Liter |

Each formulation with active ingredient is diluted with water and biological efficacy trials on target fungi are conducted.

Following experimentations were done with various mixtures of Sulphur on different types of fungi, the result of which are summarized in the below tables:

TABLE 1a
Activity of Sulphur + Difenoconazole on apple fruits incidence
for Venturia inaequalis control at 4 days after last application.

| | | Observed % | Expected % | Interaction |
|---|---|---|---|---|
| Active | Rate | control | control | Ratio |
| Ingredient | (g/ha) | (O) | (E) | (R) |
| Sulphur | 3500 | 63.60 | — | — |
| Difenoconazole | 37.5 | 67.90 | — | — |
| Difenoconazole | 50 | 69.40 | — | — |
| Sulphur + | 3500 + 37.5 | 77.60 | 72.81 | 1.07 |
| Difenoconazole | | | | |
| Sulphur + | 3500 + 50 | 83.50 | 74.08 | 1.13 |
| Difenoconazole | | | | |

TABLE 1b
Activity of Sulphur + Difenoconazole on apple fruits
classes of damage (class 1 = no damage; class 2 =
2-3 spots per fruit; class 3 = more than 3 spots per fruit)
for Venturio indequalis control at 14 days after last application.

| Active | Rate | Class 1 | Class 2 | Class 3 |
|---|---|---|---|---|
| Ingredient | (g/ha) | (%) | (%) | (%) |
| Untreated | n.a. | 82.4 | 8.3 | 9.3 |
| Sulphur | 3500 | 90.8 | 4.2 | 5.0 |
| Difenoconazole | 37.5 | 92.5 | 5.2 | 2.3 |
| Difenoconazole | 50 | 93.5 | 3.3 | 3.3 |
| Sulphur + | 3500 + 37.5 | 93.5 | 3.8 | 2.8 |
| Difenoconazole | | | | |
| Sulphur + | 3500 + 50 | 95.3 | 3.5 | 1.3 |
| Difenoconazole | | | | |

TABLE 2
Activity of Sulphur + Difenoconazole and Sulphur + Fluazinam on wheat
yield increase when applied for Zymoseptoria tritici control

| | | Yield increase |
|---|---|---|
| Active | Rate | versus the untreated |
| Ingredient | (g/ha) | (%) |
| Untreated | | 100 |
| Sulphur | 2450 | 100.12 |
| Difenoconazole | 75 | 102.26 |
| Difenoconazole | 125 | 109.14 |
| Sulphur + | 2450 + 75 | 105.76 |
| Difenoconazole | | |
| Sulphur + | 2450 + 125 | 112.3 |
| Difenoconazole | | |

TABLE 3
Activity of Sulphur + Difenoconazole and Sulphur +
Fluazinam against Alternoria solani in plates.

| | | Observed % | Expected % | Synergism |
|---|---|---|---|---|
| Active | Rate | control | control | Ratio |
| Ingredient | (g/ha) | (O) | (E) | (R) |
| Sulphur | 1400 | 58.6 | — | — |
| Difenoconazole | 25 | 60.6 | — | — |
| Fluazinam | 150 | 57.5 | — | — |
| Sulphur + | 1400 + 25 | 97.2 | 86.6 | 1.12 |
| Difenoconazole | | | | |
| Sulphur + | 1400 + 150 | 100.0 | 85.5 | 1.17 |
| Fluazinam | | | | |

TABLE 4
Activity of Sulphur + Difenoconazole and Sulphur +
Fluazinam against Botrytis cinerea in plates.

| | | Observed % | Expected % | Synergism |
|---|---|---|---|---|
| Active | Rate | control | control | Ratio |
| Ingredient | (g/ha) | (O) | (E) | (R) |
| Sulphur | 1400 | 23.6 | — | — |
| Difenoconazole | 25 | 62.5 | — | — |
| Fluazinam | 150 | 64.4 | — | — |
| Sulphur + | 1400 + 25 | 96.9 | 71.2 | 1.36 |
| Difenoconazole | | | | |
| Sulphur + | 1400 + 150 | 93.3 | 72.7 | 1.28 |
| Fluazinam | | | | |

TABLE 5
Activity of Sulphur + Difenoconazole and Sulphur + Fluazinam
against Colletotrichum gloeosporioides in plates.

| | | Observed % | Expected % | Synergism |
|---|---|---|---|---|
| Active | Rate | control | control | Ratio |
| Ingredient | (g/ha) | (O) | (E) | (R) |
| Sulphur | 1400 | 49.8 | — | — |
| Difenoconazole | 25 | 58.4 | — | — |
| Fluazinam | 150 | 60.8 | — | — |
| Sulphur + | 1400 + 25 | 96.0 | 75.8 | 1.27 |
| Difenoconazole | | | | |
| Sulphur + | 1400 + 150 | 96.3 | 77.2 | 1.25 |
| Fluazinam | | | | |

TABLE 6
Activity of Sulphur + Difenoconazole and Sulphur +
Fluazinam against Romularia collo-cygni in plates.

| | | Observed % | Expected % | Synergism |
|---|---|---|---|---|
| Active | Rate | control | control | Ratio |
| Ingredient | (g/ha) | (O) | (E) | (R) |
| Sulphur | 1400 | 62.7 | — | — |
| Difenoconazole | 25 | 73.9 | — | — |
| Fluazinam | 150 | 36.3 | — | — |
| Sulphur + | 1400 + 25 | 100 | 93.8 | 1.07 |
| Difenoconazole | | | | |
| Sulphur + | 1400 + 150 | 100 | 84.8 | 1.18 |
| Fluazinam | | | | |

Furthermore, the miticidal and insecticidal efficacy of the compositions are also evaluated with reference to a scale of 0% to 100% in comparison with untreated control plots. 0 means no control and 100 means complete control of the target pest.

The experiments were conducted by applying commercially available formulations of Sulphur and other mixture partners, alone or with their tank-mixed compositions. The compositions were diluted with water.

The active ingredients used in the experiments are having following formulation types and the concentrations:

| Active | Formulation | |
|---|---|---|
| ingredient | type | Concentration |
| Sulphur | SL | 700 gr/Liter |
| Sulphur | WG | 800 gr/kg |
| Difenoconazole | SC | 250 gr/Liter |
| Fluazinam | SC | 500 gr/Liter |

Each formulation with active ingredient is diluted with water and biological efficacy trials on target pest are conducted.

Following experimentations were done with various mixtures of Sulphur on different types of pest, the result of which are summarized in the below tables:

TABLE 7
Activity of Sulphur + Fluazinam
against Tetranychus urticae in plates.

| | | Observed % | Expected % | Synergism |
|---|---|---|---|---|
| Active | g | control | control | Ratio |
| ingredient | ai/ha | (O) | (E) | (R) |
| Sulphur (SC) | 1500 | 72.5 | | |
| | 2000 | 82.5 | | |
| | 2500 | 87.5 | | |
| | 3000 | 90 | | |
| Sulphur (WG) | 1500 | 72.5 | | |
| | 3000 | 85 | | |
| Fluazinam | 200 | 27.5 | | |
| | 250 | 32.5 | | |
| | 300 | 32.5 | | |
| | 350 | 37.5 | | |
| Sulphur (SC) + | 1500 + 200 | 100 | 80.1 | 1.25 |
| fluazinam | 1500 + 250 | 100 | 81.4 | 1.23 |
| | 1500 + 300 | 100.0 | 81.4 | 1.23 |
| | 1500 + 350 | 100.0 | 82.8 | 1.21 |
| | 2000 + 200 | 100.0 | 87.3 | 1.15 |
| | 2000 + 250 | 100.0 | 88.2 | 1.13 |
| | 2000 + 300 | 100.0 | 88.2 | 1.13 |
| | 2000 + 350 | 100.0 | 89.1 | 1.12 |
| | 2500 + 200 | 100.0 | 90.9 | 1.10 |
| | 2500 + 250 | 100.0 | 91.6 | 1.09 |
| | 2500 + 300 | 100.0 | 91.6 | 1.09 |
| | 2500 + 350 | 100.0 | 92.2 | 1.08 |
| | 3000 + 200 | 100.0 | 92.8 | 1.08 |
| | 3000 + 250 | 100.0 | 93.3 | 1.07 |
| | 3000 + 300 | 100.0 | 93.3 | 1.07 |
| | 3000 + 350 | 100.0 | 93.8 | 1.07 |
| \ | 1500 + 200 | 95.0 | 80.1 | 1.19 |
| | 1500 + 250 | 97.5 | 81.4 | 1.20 |
| | 1500 + 300 | 100.0 | 81.4 | 1.23 |
| | 1500 + 350 | 100.0 | 82.8 | 1.21 |
| | 3000 + 200 | 100.0 | 89.1 | 1.12 |
| | 3000 + 250 | 100.0 | 89.9 | 1.11 |
| | 3000 + 300 | 100.0 | 89.9 | 1.11 |
| | 3000 + 350 | 100.0 | 90.6 | 1.10 |

TABLE 8
Activity of Sulphur + Fluazinam against
Trialeurodes vaporariorum plates.

| | | Observed % | Expected % | Synergism |
|---|---|---|---|---|
| Active | g | control | control | Ratio |
| ingredient | ai/ha | (O) | (E) | (R) |
| Sulphur (SC) | 1500 | 17.5 | | |
| | 2000 | 42.1 | | |
| | 2500 | 56.1 | | |
| | 3000 | 61.6 | | |
| Sulphur (WG) | 1500 | 20.2 | | |
| | 3000 | 49.2 | | |
| Fluazinam | 200 | 21.7 | | |
| | 250 | 23.6 | | |
| | 300 | 24.1 | | |
| | 350 | 33.6 | | |
| Sulphur (SC) + | 1500 + 200 | 52.9 | 35.4 | 1.49 |
| fluazinam | 1500 + 250 | 62.5 | 37.0 | 1.69 |
| | 1500 + 300 | 70.0 | 37.4 | 1.87 |
| | 1500 + 350 | 72.6 | 45.2 | 1.61 |
| | 2000 + 200 | 58.2 | 54.7 | 1.06 |
| | 2000 + 250 | 76.3 | 55.8 | 1.37 |
| | 2000 + 300 | 80.7 | 56.1 | 1.44 |
| | 2000 + 350 | 86.7 | 61.6 | 1.41 |
| | 2500 + 200 | 72.6 | 65.6 | 1.11 |
| | 2500 + 250 | 89.0 | 66.5 | 1.34 |
| | 2500 + 300 | 91.1 | 66.7 | 1.37 |
| | 2500 + 350 | 96.4 | 70.9 | 1.36 |
| | 3000 + 200 | 70.0 | 69.9 | 1.00 |
| | 3000 + 250 | 94.3 | 70.7 | 1.33 |
| | 3000 + 300 | 92.7 | 70.9 | 1.31 |
| | 3000 + 350 | 96.4 | 74.5 | 1.29 |
| Sulphur (WG) + | 1500 + 200 | 26.1 | 37.5 | 0.70 |
| fluazinam | 1500 + 250 | 37.0 | 39.0 | 0.95 |
| | 1500 + 300 | 44.7 | 39.4 | 1.13 |
| | 1500 + 350 | 77.1 | 47.0 | 1.64 |
| | 3000 + 200 | 51.9 | 60.2 | 0.86 |
| | 3000 + 250 | 62.5 | 61.2 | 1.02 |
| | 3000 + 300 | 70.0 | 61.4 | 1.14 |
| | 3000 + 350 | 92.7 | 66.3 | 1.40 |

In some embodiments, the mixture is synergistic for enhancing crop plant. In some embodiments, the mixture is synergistic for enhancing plant development. In some other embodiments, the mixture is synergistic for enhancing root system. In some embodiments, the mixture is synergistic for improving plant quality and yields. In some embodiments, the mixture is synergistic for regulating plant growth. In some embodiments, the mixture is synergistic for controlling different species of fungi.

While the present disclosure of the invention may be susceptible to various modifications and alternative forms, specific embodiments have been described by way of example in detail herein. However, it is understood that the present disclosure is not intended to be limited to the particular forms disclosed. Rather, the present disclosure is to cover all modifications, equivalents, and alternatives falling within the scope of the present disclosure as defined by the following claims and their legal equivalents.

What is claimed is:

1. A mixture combination of active compounds comprising:
i) an effective amount of a sulphur; and
ii) an effective amount of at least one fungicide selected from the group consisting of:
(a) a contact fungicide acting as uncoupler of oxidative phosphorylation selected from a group comprising fluazinam,
(b) a triazole fungicide selected from group comprising difenoconazole, tebuconazole, metconazole, fenbuconazole, flusilazole, cyproconazole, Mefentrifluconazole, Ipfentrifluconazole, Fluoxytioconazole and prothioconazole.

2. The mixture combination of claim 1 wherein the mixture is selected from the group comprising:
A) sulphur and a contact fungicide acting as uncoupler of oxidative phosphorylation,
B) sulphur and a triazole fungicide

3. The mixture combination of any of claims 1-2, wherein the mixture is selected from the group comprising:
i) sulphur and fluazinam,
ii) sulphur and difenoconazole
iii) sulphur and mefentrifluconazole

4. The mixture combination of any one of claims 1-3, wherein the mixture exhibits synergistic effects.

5. The mixture combination of any one of claims 1-4, wherein sulphur and at least one fungicide as recited in claim 1, are applied jointly or in a succession.

6. The mixture combination of any one of claims 1-5, wherein the weight ratio of sulphur and one or more fungicide as recited in claim 1, is from 2:1 to 100:1.

7. The mixture combination of any one of claims 1-4, wherein the weight ratio of sulphur and the contact fungicide is from 2:1 to 30:1.

8. The mixture combination of claim 7, wherein the weight ratio of sulphur and fluazinam is from 2:1 to 30:1.

9. The mixture combination of any one of claims 1-4, wherein the weight ratio of sulphur and the triazole fungicide is from 5:1 to 100:1.

10. The mixture combination of claim 9, wherein the weight ratio of sulphur and difenoconazole is from 5:1 to 100:1.

11. The mixture combination of any one of claims 1-10, wherein the application rates of each active component in the mixture are from 25 g/ha to 4000 g/ha.

12. A pesticidal composition comprising: (i) the mixture combination of any one of claims 1-11; and (ii) an agriculturally acceptable carrier.

13. The pesticidal composition of claim 12, further comprising at least one surfactant, solid diluent, liquid diluent, or a combination thereof.

14. A method for treating a plant or soil against fungal infection by controlling fungi with an effective amount of the any one of the mixture combinations of any one of claims 1-11 or the composition of claim 12 or 13 so as to control fungi.

15. The method for treating a plant or soil against fungal infection by controlling fungi according to claim 14, wherein the fungi are selected from a group comprising Zymoseptoria tritici, Ramularia collo-cygni, Botrytis cinerea, Colletotrichum gloeosporioides, Alternaria solani and Venturia inaequalis.

16. The method of claim 15 for treating a plant or soil against fungal infection by controlling the fungi, Zymoseptoria tritici with an effective amount of the any one of the mixture combinations of any one of claims 1-11, in a weight ratio from 2:1 to 100:1, thereby controlling the said fungi.

17. The method of claim 16 for treating a plant or soil against fungal infection by controlling the fungi, Zymoseptoria tritici with an effective amount of the any one of the mixture combinations of sulphur and an effective amount of a contact fungicide acting as uncoupler of oxidative phosphorylation, in a weight ratio from 2:1 to 30:1, thereby controlling the said fungi.

18. The method of claim 17 for treating a plant or soil against fungal infection by controlling the fungi, Zymoseptoria tritici with an effective amount of the any one of the mixture combinations of sulphur and an effective amount of fluazinam, in a weight ratio from 2:1 to 30:1, thereby controlling the said fungi.

19. The method of claim 16 for treating a plant or soil against fungal infection by controlling the fungi, Zymoseptoria tritici with an effective amount of the any one of the mixture combinations of sulphur and an effective amount of a triazole fungicide, in a weight ratio from 5:1 to 100:1, thereby controlling the said fungi.

20. The method of claim 19 for treating a plant or soil against fungal infection by controlling the fungi, Zymoseptoria tritici with an effective amount of the any one of the mixture combinations of sulphur and an effective amount of difenoconazole, in a weight ratio from 5:1 to 100:1, thereby controlling the said fungi.

21. The method of claim 15 for treating a plant or soil against fungal infection by controlling the fungi, Ramularia collo-cygni with an effective amount of the any one of the mixture combinations of any one of claims 1-11, in a weight ratio from 2:1 to 100:1, thereby controlling the said fungi.

22. The method of claim 21 for treating a plant or soil against fungal infection by controlling the fungi, Ramularia collo-cygni with an effective amount of the any one of the mixture combinations of sulphur and an effective amount of a contact fungicide acting as uncoupler of oxidative phosphorylation, in a weight ratio from 2:1 to 30:1, thereby controlling the said fungi.

23. The method of claim 22 for treating a plant or soil against fungal infection by controlling the fungi, Ramularia collo-cygni with an effective amount of the any one of the mixture combinations of sulphur and an effective amount of fluazinam, in a weight ratio from 2:1 to 30:1, thereby controlling the said fungi.

24. The method of claim 21 for treating a plant or soil against fungal infection by controlling the fungi, Ramularia collo-cygni with an effective amount of the any one of the mixture combinations of sulphur and an effective amount of a triazole fungicide, in a weight ratio from 5:1 to 100:1, thereby controlling the said fungi.

25. The method of claim 24 for treating a plant or soil against fungal infection by controlling the fungi, Ramularia collo-cygni with an effective amount of the any one of the mixture combinations of sulphur and an effective amount of difenoconazole, in a weight ratio from 5:1 to 100:1, thereby controlling the said fungi.

26. The method of claim 15 for treating a plant or soil against fungal infection by controlling the fungi, Botrytis cinerea with an effective amount of the any one of the mixture combinations of any one of claims 1-11, in a weight ratio from 2:1 to 100:1, thereby controlling the said fungi.

27. The method of claim 26 for treating a plant or soil against fungal infection by controlling the fungi, Botrytis cinerea with an effective amount of the any one of the mixture combinations of sulphur and an effective amount of a contact fungicide acting as uncoupler of oxidative phosphorylation, in a weight ratio from 2:1 to 30:1, thereby controlling the said fungi.

28. The method of claim 27 for treating a plant or soil against fungal infection by controlling the fungi, Botrytis cinerea with an effective amount of the any one of the mixture combinations of sulphur and an effective amount of fluazinam, in a weight ratio from 2:1 to 30:1, thereby controlling the said fungi.

29. The method of claim 26 for treating a plant or soil against fungal infection by controlling the fungi, Botrytis cinerea with an effective amount of the any one of the mixture combinations of sulphur and an effective amount of a triazole fungicide, in a weight ratio from 5:1 to 100:1, thereby controlling the said fungi.

30. The method of claim 29 for treating a plant or soil against fungal infection by controlling the fungi, Botrytis cinerea with an effective amount of the any one of the mixture combinations of sulphur and an effective amount of difenoconazole, in a weight ratio from 5:1 to 100:1, thereby controlling the said fungi.

31. The method of claim 15 for treating a plant or soil against fungal infection by controlling the fungi, Colletotrichum gloeosporioides with an effective amount of the any one of the mixture combinations of any one of claims 1-11, in a weight ratio from 2:1 to 100:1, thereby controlling the said fungi.

32. The method of claim 31 for treating a plant or soil against fungal infection by controlling the fungi, Colletotrichum gloeosporioides with an effective amount of the any one of the mixture combinations of sulphur and an effective amount of a contact fungicide acting as uncoupler of oxidative phosphorylation, in a weight ratio from 2:1 to 30:1, thereby controlling the said fungi.

33. The method of claim 32 for treating a plant or soil against fungal infection by controlling the fungi, Colletotrichum gloeosporioides with an effective amount of the any one of the mixture combinations of sulphur and an effective amount of fluazinam, in a weight ratio from 2:1 to 30:1, thereby controlling the said fungi.

34. The method of claim 31 for treating a plant or soil against fungal infection by controlling the fungi, Colletotrichum gloeosporioides with an effective amount of the any one of the mixture combinations of sulphur and an effective amount of a triazole fungicide, in a weight ratio from 5:1 to 100:1, thereby controlling the said fungi.

35. The method of claim 34 for treating a plant or soil against fungal infection by controlling the fungi, Colletotrichum gloeosporioides with an effective amount of the any one of the mixture combinations of sulphur and an effective amount of difenoconazole, in a weight ratio from 5:1 to 100:1, thereby controlling the said fungi.

36. The method of claim 15 for treating a plant or soil against fungal infection by controlling the fungi, Alternaria solani with an effective amount of the any one of the mixture combinations of any one of claims 1-11, in a weight ratio from 2:1 to 100:1, thereby controlling the said fungi.

37. The method of claim 36 for treating a plant or soil against fungal infection by controlling the fungi, Alternaria solani with an effective amount of the any one of the mixture combinations of sulphur and an effective amount of a contact fungicide acting as uncoupler of oxidative phosphorylation, in a weight ratio from 2:1 to 30:1, thereby controlling the said fungi.

38. The method of claim 37 for treating a plant or soil against fungal infection by controlling the fungi, Alternaria solani with an effective amount of the any one of the mixture combinations of sulphur and an effective amount of fluazinam, in a weight ratio from 2:1 to 30:1, thereby controlling the said fungi.

39. The method of claim 36 for treating a plant or soil against fungal infection by controlling the fungi, Alternaria solani with an effective amount of the any one of the mixture combinations of sulphur and an effective amount of a triazole fungicide, in a weight ratio from 5:1 to 100:1, thereby controlling the said fungi.

40. The method of claim 39 for treating a plant or soil against fungal infection by controlling the fungi, Alternaria solani with an effective amount of the any one of the mixture combinations of sulphur and an effective amount of difenoconazole, in a weight ratio from 5:1 to 100:1, thereby controlling the said fungi.

41. The method of claim 15 for treating a plant or soil against fungal infection by controlling the fungi, Venturia inaequalis with an effective amount of the any one of the mixture combinations of any one of claims 1-11, in a weight ratio from 2:1 to 100:1, thereby controlling the said fungi.

42. The method of claim 41 for treating a plant or soil against fungal infection by controlling the fungi, Venturia inaequalis with an effective amount of the any one of the mixture combinations of sulphur and an effective amount of a contact fungicide acting as uncoupler of oxidative phosphorylation, in a weight ratio from 2:1 to 30:1, thereby controlling the said fungi.

43. The method of claim 42 for treating a plant or soil against fungal infection by controlling the fungi Venturia inaequalis with an effective amount of the any one of the mixture combinations of sulphur and an effective amount of fluazinam, in a weight ratio from 2:1 to 30:1, thereby controlling the said fungi.

44. The method of claim 41 for treating a plant or soil against fungal infection by controlling the fungi, Venturia inaequalis with an effective amount of the any one of the mixture combinations of sulphur and an effective amount of a triazole fungicide, in a weight ratio from 5:1 to 100:1, thereby controlling the said fungi.

45. The method of claim 44 for treating a plant or soil against fungal infection by controlling the fungi, Venturia inaequalis with an effective amount of the any one of the mixture combinations of sulphur and an effective amount of difenoconazole, in a weight ratio from 5:1 to 100:1, thereby controlling the said fungi.

46. A method for control of insects by contacting the insect or their food supply, habitat, breeding grounds or their locus with an effective amount of any one of the mixture combinations of any one of claims 1-11 or the composition of claim 12 or 13 so as to control insects.

47. The method for controlling insects according to claim 46, wherein the insects are selected from a group comprising Tetranychus urticae and Trialeurodes vaporariorum.

48. The method of claim 47 for controlling the insect, Tetranychus urticae by contacting the insect or their food supply, habitat, breeding grounds or their locus with an effective amount of the mixture combination of any one of claims 1-11, in a weight ratio from 2:1 to 100:1, so as to controlling the said insect.

49. The method of claim 48 for controlling the insect, Tetranychus urticae by contacting the insect or their food supply, habitat, breeding grounds or their locus with an effective amount of the any one of the mixture combinations of sulphur and an effective amount of a contact fungicide acting as uncoupler of oxidative phosphorylation, in a weight ratio from 2:1 to 30:1, so as to controlling the said insect.

50. The method of claim 49 for controlling the insect, Tetranychus urticae by contacting the insect or their food supply, habitat, breeding grounds or their locus with an effective amount of the any one of the mixture combinations of sulphur and an effective amount of fluazinam, in a weight ratio from 2:1 to 30:1, so as to controlling the said insect.

51. The method of claim 47 for controlling the insect, Trialeurodes vaporariorum by contacting the insect or their food supply, habitat, breeding grounds or their locus with an effective amount of the mixture combination of any one of claims 1-11, in a weight ratio from 2:1 to 100:1, so as to controlling the said insect.

52. The method of claim 51 for controlling the insect, Trialeurodes vaporariorum by contacting the insect or their food supply, habitat, breeding grounds or their locus with an effective amount of the any one of the mixture combinations of sulphur and an effective amount of a contact fungicide acting as uncoupler of oxidative phosphorylation, in a weight ratio from 2:1 to 30:1, so as to controlling the said insect.

53. The method of claim 52 for controlling the insect, Trialeurodes vaporariorum by contacting the insect or their food supply, habitat, breeding grounds or their locus with an effective amount of the any one of the mixture combinations of sulphur and an effective amount of fluazinam, in a weight ratio from 2:1 to 30:1, so as to controlling the said insect.
